(19) United States
(12) Patent Application Publication
(10) Pub. No.: US 2024/0056261 A1
(43) Pub. Date: Feb. 15, 2024

(54) SOUNDING REFERENCE SIGNAL INDICATOR DESIGNS FOR NON-CODEBOOK-BASED COMMUNICATIONS

(71) Applicant: QUALCOMM Incorporated, San Diego, CA (US)

(72) Inventors: Mostafa KHOSHNEVISAN, San Diego, CA (US); Yitao CHEN, San Diego, CA (US); Xiaoxia ZHANG, San Diego, CA (US)

(21) Appl. No.: 18/446,142

(22) Filed: Aug. 8, 2023

Related U.S. Application Data
(60) Provisional application No. 63/397,362, filed on Aug. 11, 2022.

(51) Int. Cl. H04L 5/00; H04W 72/56; H04W 72/1268; H04W 72/232

(52) U.S. Cl. CPC H04L 5/0051; H04W 72/56; H04W 72/1268; H04W 72/232

(57) ABSTRACT

Methods, systems, and devices for method for wireless communication are described. A UE may receive one or more control messages that indicate a quantity of sounding reference signal (SRS) resource sets, a quantity of one or more SRS resource indicator fields included in one or more control messages, and a set of parameters, and at least one maximum rank value associated with uplink shared channel transmissions and based on a threshold quantity of rank values supported by the UE. The UE receives a downlink control information (DCI) message including DCI and including the one or more SRS resource indicator fields, and interprets the one or more SRS resource indicator fields based on a quantity of the at least one maximum rank value.

### CROSS REFERENCE

The present application for patent claims the benefit of U.S. Provisional Patent Application No. 63/397,362 by KHOSHNEVISAN et al., entitled “SOUNDING REFERENCE SIGNAL INDICATOR DESIGN FOR NON-CODEBOOK-BASED COMMUNICATIONS,” filed Aug. 11, 2022, assigned to the assignee hereof, and expressly incorporated by reference herein.

### FIELD OF TECHNOLOGY

The following relates to method for wireless communication, including sounding reference signal (SRS) indicator designs for non-codebook (CB)-based communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sounding reference signal (SRS) indicator designs for non-codebook (CB)-based communications. For example, the described techniques provide for a signaling-based mechanism according to which a user equipment (UE) may dynamically switch between communicating with a single transmission and reception point (TRP) in a single TRP (sTRP) operation mode and communicating with multiple TRPs in a multi-TRP (mTRP) operation mode while supporting various configurations relating to how many layers the UE may use for uplink shared channel transmissions, such as physical uplink shared channel (PUSCH) transmissions. In some aspects, the physical uplink shared channel transmissions may include two or more PUSCH transmissions that at least partially overlap in a time domain. In some implementations, for example, the UE may use an interpretation of one or more downlink control information (DCI) fields in accordance with receiving one or more control messages and one or more rules. In some implementations, the interpretation of the DCI may refer to how the UE interprets a content of one or more SRS resource indicator (SRI) fields included in a DCI scheduling a non-CB-based PUSCH transmission.

A method for wireless communication by a UE is described. The method may include receiving one or more control messages that indicate: a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage; and at least one maximum rank value that is associated with uplink shared channel transmissions from the UE, the at least one maximum rank value being based on a threshold quantity of rank values supported by the UE. In some examples, the method may include receiving a DCI message including DCI that schedules at least one uplink shared channel message, the DCI message including the one or more SRS resource indicator fields, interpreting the one or more SRS resource indicator fields based on a quantity of the at least one maximum rank value, and transmitting the at least one uplink shared channel message in accordance with interpreting the one or more SRS resource indicator fields.

A UE for wireless communication is described. The UE may include one or more memories and one or more processors coupled to the one or more memories. The one or more processors may be individually or collectively configured to receive one or more control messages that indicate: a quantity of a set of multiple sounding reference signal (SRS) resource sets, a quantity of one or more SRS resource indicator fields included in one or more control messages, and a set of parameters for multiple uplink shared channel messages, where the set of multiple SRS resource sets are configured for non-CB usage; and at least one maximum rank value that be associated with uplink shared channel transmissions from the UE, the at least one maximum rank value being based on a threshold quantity of rank values supported by the UE. In some examples, the one or more processors may be individually or collectively configured to receive a DCI message including DCI that schedules at least one uplink shared channel message, the DCI message including the one or more SRS resource indicator fields, interpret the one or more SRS resource indicator fields based on a quantity of the at least one maximum rank value, and transmit the at least one uplink shared channel message in accordance with interpreting the one or more SRS resource indicator fields.

Another UE for wireless communication is described. The UE may include means for receiving one or more control messages that indicate: a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage; and at least one maximum rank value that is associated with uplink shared channel transmissions from the UE, the at least one maximum rank value being based on a threshold quantity of rank values supported by the UE. In some examples, the UE may include means for receiving a DCI message including DCI that schedules at least one uplink shared channel message, the DCI message including the one or more SRS resource indicator fields, means for interpreting the one or more SRS resource indicator fields based on a quantity of the at least one maximum rank value, and means for transmitting the at least one uplink shared channel message in accordance with interpreting the one or more SRS resource indicator fields.

A non-transitory computer-readable medium storing code for wireless communication is described. The code may include instructions executable by one or more processors to receive one or more control messages that indicate: a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage; and at least one maximum rank value that be associated with uplink shared channel transmissions from the UE, the at least one maximum rank value being based on a threshold quantity of rank values supported by the UE. In some examples, the instructions may be executable by the one or more processors to receive a DCI message including DCI that schedules at least one uplink shared channel message, the DCI message including the one or more SRS resource indicator fields, interpret the one or more SRS resource indicator fields based on a quantity of the at least one maximum rank value, and transmit the at least one uplink shared channel message in accordance with interpreting the one or more SRS resource indicator fields.

In some examples of the method, UEs, and non-transitory computer-readable medium described herein, receiving the one or more control messages may include operations, features, means, instructions, or one or more processors configured for receiving an indication of a configuration associated with the at least one maximum rank value, where the configuration may be either a first configuration or a second configuration, where, the first configuration indicates that, if the at least one uplink shared channel message is associated with a single SRS resource set, a maximum rank value associated with the at least one uplink shared channel message may be equal to a larger of a first maximum rank value associated with a first SRS resource set and a second maximum rank value associated with a second SRS resource set, and the second configuration indicates that, if the at least one uplink shared channel message is associated with the single SRS resource set, the maximum rank value associated with the at least one uplink shared channel message may be equal to a summation of the first maximum rank value associated with the first SRS resource set and the second maximum rank value associated with the second SRS resource set.

Some examples of the method, UEs, and non-transitory computer-readable medium described herein may further include operations, features, means, instructions, or one or more processors configured for transmitting, via a capability report, information associated with the maximum rank value the UE may be capable of supporting when the at least one uplink shared channel message may be associated with the single SRS resource set, or when the at least one uplink shared channel message may be associated with multiple SRS resource sets, or both.

In some examples of the method, UEs, and non-transitory computer-readable medium described herein, receiving the one or more control messages may include operations, features, means, instructions, or one or more processors configured for receiving an indication of a respective maximum rank value for each respective SRS resource set of the set of multiple SRS resource sets configured at the UE.

In some examples of the method, UEs, and non-transitory computer-readable medium described herein, receiving the one or more control messages may include operations, features, means, instructions, or one or more processors configured for receiving an indication of a first maximum rank value corresponding to a quantity of layers of a first uplink shared channel message associated with a first control resource set index value, where a second uplink shared channel message associated with a second control resource set index value partially overlaps with the first uplink shared channel message and receiving the indication of the first maximum rank value corresponding to the quantity of layers of the first uplink shared channel message associated with the first control resource set index value, where the second uplink shared channel message associated with the second control resource set index value may be absent.

Some examples of the method, UEs, and non-transitory computer-readable medium described herein may further include operations, features, means, instructions, or one or more processors configured for receiving a second indication of a second maximum rank value corresponding to the quantity of layers of the second uplink shared channel message associated with the second control resource set index value.

In some examples of the method, UEs, and non-transitory computer-readable medium described herein, the first maximum rank value and the second maximum rank value may be the same or different.

In some examples of the method, UEs, and non-transitory computer-readable medium described herein, the first maximum rank value and the second maximum rank value may be configured in accordance with at least one of a control message format, a bandwidth part, a component carrier, or a combination thereof.

In some examples of the method, UEs, and non-transitory computer-readable medium described herein, transmitting the at least one uplink shared channel message may include operations, features, means, instructions, or one or more processors configured for transmitting the at least one uplink shared channel message in accordance with one or more rules associated with a quantity of a set of multiple SRS resources, where the one or more rules state that a first maximum quantity of SRS resources is to be indicated for a first uplink shared channel message associated with a first control resource set index value, where a second uplink shared channel message associated with a second control resource set index value partially overlaps with the first uplink shared channel message in a common component carrier.

In some examples of the method, UEs, and non-transitory computer-readable medium described herein, the one or more rules state that a second maximum quantity of the SRS resources is to be indicated for the second uplink shared channel message associated with the second control resource set index value.

Some examples of the method, UEs, and non-transitory computer-readable medium described herein may further include operations, features, means, instructions, or one or more processors configured for receiving a control message indicating the first maximum quantity of the SRS resources and the second maximum quantity of the SRS resources.

In some examples of the method, UEs, and non-transitory computer-readable medium described herein, a summation of the first maximum quantity of the SRS resources and the second maximum quantity of the SRS resources may be less than or equal to the at least one maximum rank value.

In some examples of the method, UEs, and non-transitory computer-readable medium described herein, receiving the one or more control messages may include operations, features, means, instructions, or one or more processors configured for receiving an indication of a first SRS resource set of the set of multiple SRS resource sets and a second SRS resource set of the set of multiple SRS resource sets, where the first SRS resource set may be associated with a first uplink shared channel message and the second SRS resource set may be associated with a second uplink shared channel message.

In some examples of the method, UEs, and non-transitory computer-readable medium described herein, transmitting the at least one uplink shared channel message may include operations, features, means, instructions, or one or more processors configured for transmitting the at least one uplink shared channel message in accordance with one or more rules associated with the set of multiple SRS resource sets, where the one or more rules state that a first maximum quantity of SRS resources including a subset of the first SRS resource set to be indicated for the first uplink shared channel message associated with a first control resource set index value, where the second uplink shared channel message associated with a second control resource set index value partially overlaps with the first uplink shared channel message in a common component carrier.

In some examples of the method, UEs, and non-transitory computer-readable medium described herein, the one or more rules state that a second maximum quantity of SRS resources including a subset of the second SRS resource set to be indicated for the second uplink shared channel message associated with the second control resource set index value.

Some examples of the method, UEs, and non-transitory computer-readable medium described herein may further include operations, features, means, instructions, or one or more processors configured for receiving a control message indicating the first maximum quantity of the SRS resources and the second maximum quantity of the SRS resources.

Some examples of the method, UEs, and non-transitory computer-readable medium described herein may further include operations, features, means, instructions, or one or more processors configured for transmitting, via a capability report, information indicating the first maximum quantity of the SRS resources and the second maximum quantity of the SRS resources.

In some examples of the method, UEs, and non-transitory computer-readable medium described herein, the first maximum quantity of the SRS resources may be equal to half of the first SRS resource set and the second maximum quantity of the SRS resources may be equal to half of the second SRS resource set.

In some examples of the method, UEs, and non-transitory computer-readable medium described herein, receiving the one or more control messages may include operations, features, means, instructions, or one or more processors configured for receiving an indication of a first SRS resource set of the set of multiple SRS resource sets for the first uplink shared channel message associated with a first control resource set index value, where the second uplink shared channel message associated with a second control resource set index value may be absent, receiving the indication of a second SRS resource set of the set of multiple SRS resource sets for the second uplink shared channel message associated with the second control resource set index value, where the first uplink shared channel message associated with the first control resource set index value may be absent, receiving the indication of a third SRS resource set of the set of multiple SRS resource sets for the first uplink shared channel message associated with the first control resource set index value, where the second uplink shared channel message associated with the second control resource set index value partially overlaps with the first uplink shared channel message, and receiving the indication of a fourth SRS resource set of the set of multiple SRS resource sets for the second uplink shared channel message associated with the second control resource set index value, where the first uplink shared channel message associated with the first control resource set index value partially overlaps with the second uplink shared channel message.

In some examples of the method, UEs, and non-transitory computer-readable medium described herein, the first SRS resource set and the third SRS resource set may be associated with a common channel state information resource set and a common set of power control parameters.

In some examples of the method, UEs, and non-transitory computer-readable medium described herein, the second SRS resource set and the fourth SRS resource set may be associated with a common channel state information resource set and a common set of power control parameters.

In some examples of the method, UEs, and non-transitory computer-readable medium described herein, a quantity of resources in the third SRS resource set may be less than a quantity of resources in the first SRS resource set.

In some examples of the method, UEs, and non-transitory computer-readable medium described herein, a quantity of resources in the fourth SRS resource set may be less than a quantity of resources in the second SRS resource set.

In some examples of the method, UEs, and non-transitory computer-readable medium described herein, receiving the one or more control messages may include operations, features, means, instructions, or one or more processors configured for receiving an indication of a first maximum rank value corresponding to the first uplink shared channel message associated with a first control resource set index value, where the second uplink shared channel message associated with a second control resource set index value may be absent and receiving the indication of a second maximum rank value corresponding to the first uplink shared channel message associated with the first control resource set index value and a third maximum rank value corresponding to the second uplink shared channel message associated with the second control resource set index value, where the second uplink shared channel message associated with the second control resource set index value partially overlaps with the first uplink shared channel message.

In some examples of the method, UEs, and non-transitory computer-readable medium described herein, the second maximum rank value and the third maximum rank value may be the same or different.

In some examples of the method, UEs, and non-transitory computer-readable medium described herein, the second maximum rank value and the third maximum rank value may be configured in accordance with at least one of a control message format, a bandwidth part, a component carrier, or a combination thereof.

In some examples of the method, UEs, and non-transitory computer-readable medium described herein, a summation of the second maximum rank value and the third maximum rank value may be less than or equal to the first maximum rank value.

Some examples of the method, UEs, and non-transitory computer-readable medium described herein may further include operations, features, means, instructions, or one or more processors configured for receiving a control message including an indication of SRS resource set selection, where interpreting the one or more SRS resource indicator fields may be based on the indication of SRS resource set selection and the first control resource set index value or the second control resource set index value.

In some examples of the method, UEs, and non-transitory computer-readable medium described herein, the one or more control messages include an indication of a presence of multiple uplink shared channel messages that overlap at least partially in a time domain.

A method for wireless communication by a network entity is described. The method may include transmitting one or more control messages that indicate: a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage; and at least one maximum rank value that is associated with uplink shared channel transmissions from a UE, the at least one maximum rank value being based on a threshold quantity of rank values supported by the UE. In some examples, the method may include transmitting a DCI message including DCI that schedules at least one uplink shared channel message, the DCI message including one or more SRS resource indicator fields, and receiving the at least one uplink shared channel message in accordance with interpreting the one or more SRS resource indicator fields, where the one or more SRS resource indicator fields is interpreted based on a quantity of the at least one maximum rank value.

A network entity for wireless communication is described. The network entity may include one or more memories and one or more processors coupled to the one or more memories. The one or more processors may be individually or collectively configured to transmit one or more control messages that indicate: a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage; and at least one maximum rank value that be associated with uplink shared channel transmissions from a UE, the at least one maximum rank value being based on a threshold quantity of rank values supported by the UE. In some examples, the one or more processors may be individually or collectively configured to transmit a DCI message including DCI that schedules at least one uplink shared channel message, the DCI message including one or more SRS resource indicator fields, and receive the at least one uplink shared channel message in accordance with interpreting the one or more SRS resource indicator fields, where the one or more SRS resource indicator fields is interpreted based on a quantity of the at least one maximum rank value.

Another network entity for wireless communication is described. The network entity may include means for transmitting one or more control messages that indicate: a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage; and at least one maximum rank value that is associated with uplink shared channel transmissions from a UE, the at least one maximum rank value being based on a threshold quantity of rank values supported by the UE. In some examples, the network entity may include means for transmitting a DCI message including DCI that schedules at least one uplink shared channel message, the DCI message including one or more SRS resource indicator fields, and means for receiving the at least one uplink shared channel message in accordance with interpreting the one or more SRS resource indicator fields, where the one or more SRS resource indicator fields is interpreted based on a quantity of the at least one maximum rank value.

A non-transitory computer-readable medium storing code for wireless communication at a network entity is described. The code may include instructions executable by one or more processors to transmit one or more control messages that indicate: a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage; and at least one maximum rank value that be associated with uplink shared channel transmissions from a UE, the at least one maximum rank value being based on a threshold quantity of rank values supported by the UE. In some examples, the instructions may be executable by the one or more processors to transmit a DCI message including DCI that schedules at least one uplink shared channel message, the DCI message including one or more SRS resource indicator fields, and receive the at least one uplink shared channel message in accordance with interpreting the one or more SRS resource indicator fields, where the one or more SRS resource indicator fields is interpreted based on a quantity of the at least one maximum rank value.

In some examples of the method, network entities, and non-transitory computer-readable medium described herein, transmitting the one or more control messages may include operations, features, means, instructions, or one or more processors configured for transmitting an indication of a configuration associated with the at least one maximum rank value, where the configuration may be either a first configuration or a second configuration, where, the first configuration indicates that, if the at least one uplink shared channel message is associated with a single SRS resource set, a maximum rank value associated with the at least one uplink shared channel message may be equal to a larger of a first maximum rank value associated with a first SRS resource set and a second maximum rank value associated with a second SRS resource set, and the second configuration indicates that, if the at least one uplink shared channel message is associated with the single SRS resource set, the maximum rank value associated with the at least one uplink shared channel message may be equal to a summation of the first maximum rank value associated with the first SRS resource set and the second maximum rank value associated with the second SRS resource set.

Some examples of the method, network entities, and non-transitory computer-readable medium described herein may further include operations, features, means, instructions, or one or more processors configured for receiving, via a capability report, information associated with the maximum rank value the UE may be capable of supporting when the at least one uplink shared channel message may be associated with the single SRS resource set, or when the at least one uplink shared channel message may be associated with multiple SRS resource sets, or both.

In some examples of the method, network entities, and non-transitory computer-readable medium described herein, transmitting the one or more control messages may include operations, features, means, instructions, or one or more processors configured for transmitting an indication of a respective maximum rank value for each respective SRS resource set of the set of multiple SRS resource sets configured at the UE.

In some examples of the method, network entities, and non-transitory computer-readable medium described herein, transmitting the one or more control messages may include operations, features, means, instructions, or one or more processors configured for transmitting an indication of a first maximum rank value corresponding to a quantity of layers of a first uplink shared channel message associated with a first control resource set index value, where a second uplink shared channel message associated with a second control resource set index value partially overlaps with the first uplink shared channel message and transmitting the indication of the first maximum rank value corresponding to the quantity of layers of the first uplink shared channel message associated with the first control resource set index value, where the second uplink shared channel message associated with the second control resource set index value may be absent.

Some examples of the method, network entities, and non-transitory computer-readable medium described herein may further include operations, features, means, instructions, or one or more processors configured for transmitting a second indication of a second maximum rank value corresponding to the quantity of layers of the second uplink shared channel message associated with the second control resource set index value.

In some examples of the method, network entities, and non-transitory computer-readable medium described herein, the first maximum rank value and the second maximum rank value may be the same or different.

In some examples of the method, network entities, and non-transitory computer-readable medium described herein, the first maximum rank value and the second maximum rank value may be configured in accordance with at least one of a control message format, a bandwidth part, a component carrier, or a combination thereof.

In some examples of the method, network entities, and non-transitory computer-readable medium described herein, receiving the at least one uplink shared channel message may include operations, features, means, instructions, or one or more processors configured for receiving the at least one uplink shared channel message in accordance with one or more rules associated with a quantity of a set of multiple SRS resources, where the one or more rules state that a first maximum quantity of SRS resources to be indicated for a first uplink shared channel message associated with a first control resource set index value, where a second uplink shared channel message associated with a second control resource set index value partially overlaps with the first uplink shared channel message in a common component carrier.

In some examples of the method, network entities, and non-transitory computer-readable medium described herein, the one or more rules state that a second maximum quantity of the SRS resources to be indicated for the second uplink shared channel message associated with the second control resource set index value.

Some examples of the method, network entities, and non-transitory computer-readable medium described herein may further include operations, features, means, instructions, or one or more processors configured for transmitting a control message indicating the first maximum quantity of the SRS resources and the second maximum quantity of the SRS resources.

In some examples of the method, network entities, and non-transitory computer-readable medium described herein, a summation of the first maximum quantity of the SRS resources and the second maximum quantity of the SRS resources may be less than or equal to the at least one maximum rank value.

In some examples of the method, network entities, and non-transitory computer-readable medium described herein, transmitting the one or more control messages may include operations, features, means, instructions, or one or more processors configured for transmitting an indication of a first SRS resource set of the set of multiple SRS resource sets and a second SRS resource set of the set of multiple SRS resource sets, where the first SRS resource set may be associated with a first uplink shared channel message and the second SRS resource set may be associated with a second uplink shared channel message.

In some examples of the method, network entities, and non-transitory computer-readable medium described herein, receiving the at least one uplink shared channel message may include operations, features, means, instructions, or one or more processors configured for receiving the at least one uplink shared channel message in accordance with one or more rules associated with the set of multiple SRS resource sets, where the one or more rules state that a first maximum quantity of SRS resources including a subset of the first SRS resource set to be indicated for the first uplink shared channel message associated with a first control resource set index value, where the second uplink shared channel message associated with a second control resource set index value partially overlaps with the first uplink shared channel message in a common component carrier.

In some examples of the method, network entities, and non-transitory computer-readable medium described herein, the one or more rules state that a second maximum quantity of SRS resources including a subset of the second SRS resource set to be indicated for the second uplink shared channel message associated with the second control resource set index value.

Some examples of the method, network entities, and non-transitory computer-readable medium described herein may further include operations, features, means, instructions, or one or more processors configured for transmitting a control message indicating the first maximum quantity of the SRS resources and the second maximum quantity of the SRS resources.

Some examples of the method, network entities, and non-transitory computer-readable medium described herein may further include operations, features, means, instructions, or one or more processors configured for receiving, via a capability report, information indicating the first maximum quantity of the SRS resources and the second maximum quantity of the SRS resources.

In some examples of the method, network entities, and non-transitory computer-readable medium described herein, the first maximum quantity of the SRS resources may be equal to half of the first SRS resource set and the second maximum quantity of the SRS resources may be equal to half of the second SRS resource set.

In some examples of the method, network entities, and non-transitory computer-readable medium described herein, transmitting the one or more control messages may include operations, features, means, instructions, or one or more processors configured for transmitting an indication of a first SRS resource set of the set of multiple SRS resource sets for the first uplink shared channel message associated with a first control resource set index value, where the second uplink shared channel message associated with a second control resource set index value may be absent, transmitting the indication of a second SRS resource set of the set of multiple SRS resource sets for the second uplink shared channel message associated with the second control resource set index value, where the first uplink shared channel message associated with the first control resource set index value may be absent, transmitting the indication of a third SRS resource set of the set of multiple SRS resource sets for the first uplink shared channel message associated with the first control resource set index value, where the second uplink shared channel message associated with the second control resource set index value partially overlaps with the first uplink shared channel message, and transmitting the indication of a fourth SRS resource set of the set of multiple SRS resource sets for the second uplink shared channel message associated with the second control resource set index value, where the first uplink shared channel message associated with the first control resource set index value partially overlaps with the second uplink shared channel message.

In some examples of the method, network entities, and non-transitory computer-readable medium described herein, the first SRS resource set and the third SRS resource set may be associated with a common channel state information resource set and a common set of power control parameters.

In some examples of the method, network entities, and non-transitory computer-readable medium described herein, the second SRS resource set and the fourth SRS resource set may be associated with a common channel state information resource set and a common set of power control parameters.

In some examples of the method, network entities, and non-transitory computer-readable medium described herein, a quantity of resources in the third SRS resource set may be less than a quantity of resources in the first SRS resource set.

In some examples of the method, network entities, and non-transitory computer-readable medium described herein, a quantity of resources in the fourth SRS resource set may be less than a quantity of resources in the second SRS resource set.

In some examples of the method, network entities, and non-transitory computer-readable medium described herein, transmitting the one or more control messages may include operations, features, means, instructions, or one or more processors configured for transmitting an indication of a first maximum rank value corresponding to the first uplink shared channel message associated with a first control resource set index value, where the second uplink shared channel message associated with a second control resource set index value may be absent and transmitting the indication of a second maximum rank value corresponding to the first uplink shared channel message associated with the first control resource set index value and a third maximum rank value corresponding to the second uplink shared channel message associated with the second control resource set index value, where the second uplink shared channel message associated with the second control resource set index value partially overlaps with the first uplink shared channel message.

In some examples of the method, network entities, and non-transitory computer-readable medium described herein, the second maximum rank value and the third maximum rank value may be the same or different.

In some examples of the method, network entities, and non-transitory computer-readable medium described herein, the second maximum rank value and the third maximum rank value may be configured in accordance with at least one of a control message format, a bandwidth part, a component carrier, or a combination thereof.

In some examples of the method, network entities, and non-transitory computer-readable medium described herein, a summation of the second maximum rank value and the third maximum rank value may be less than or equal to the first maximum rank value.

Some examples of the method, network entities, and non-transitory computer-readable medium described herein may further include operations, features, means, instructions, or one or more processors configured for transmitting a control message including an indication of SRS resource set selection, where interpreting the one or more SRS resource indicator fields may be based on the indication of SRS resource set selection and the first control resource set index value or the second control resource set index value.

In some examples of the method, network entities, and non-transitory computer-readable medium described herein, the one or more control messages include an indication of a presence of multiple uplink shared channel messages that overlap at least partially in a time domain.

### BRIEF DESCRIPTION OF THE DRAWINGS

FIG. 1 illustrates an example of a wireless communications system that supports sounding reference signal (SRS) indicator designs for non-codebook (CB)-based communications in accordance with one or more aspects of the present disclosure.

FIG. 2 illustrates an example of a wireless communications system that supports SRS indicator designs for non-CB-based communications in accordance with one or more aspects of the present disclosure.

FIG. 3 illustrates an example of a multi-transmission and reception point (TRP) transmission scheme that supports SRS indicator designs for non-CB-based communications in accordance with one or more aspects of the present disclosure.

FIG. 4 illustrates an example of a resource selection procedure that supports SRS indicator designs for non-CB-based communications in accordance with one or more aspects of the present disclosure.

FIG. 5 illustrates an example of a resource selection procedure that supports SRS indicator designs for non-CB-based communications in accordance with one or more aspects of the present disclosure.

FIG. 6 illustrates an example of a process flow in a system that supports SRS indicator designs for non-CB-based communications in accordance with one or more aspects of the present disclosure.

FIGS. 7 and 8 show block diagrams of devices that support SRS indicator designs for non-CB-based communications in accordance with one or more aspects of the present disclosure.

FIG. 9 shows a block diagram of a communications manager that supports SRS indicator designs for non-CB-based communications in accordance with one or more aspects of the present disclosure.

FIG. 10 shows a diagram of a system including a device that supports SRS indicator designs for non-CB-based communications in accordance with one or more aspects of the present disclosure.

FIGS. 11 and 12 show block diagrams of devices that support SRS indicator designs for non-CB-based communications in accordance with one or more aspects of the present disclosure.

FIG. 13 shows a block diagram of a communications manager that supports SRS indicator designs for non-CB-based communications in accordance with one or more aspects of the present disclosure.

FIG. 14 shows a diagram of a system including a device that supports SRS indicator designs for non-CB-based communications in accordance with one or more aspects of the present disclosure.

FIGS. 15 through 18 show flowcharts illustrating methods that support SRS indicator designs for non-CB-based communications in accordance with one or more aspects of the present disclosure.

### DETAILED DESCRIPTION

In some wireless communications systems, a network entity may dynamically schedule an uplink shared channel message, such as a physical uplink shared channel (PUSCH) message, from a user equipment (UE) via a downlink control information (DCI) message. Such a DCI message may be referred to herein as a scheduling DCI, and may indicate information associated with the PUSCH message to be transmitted from the UE. Such information may include beamforming or panel information and may indicate whether a transmission is a single transmission and reception point (TRP, such as sTRP) transmission or a multi-TRP (mTRP) transmission, and may be indicated or conveyed via an indication of one or more sounding reference signal (SRS) resources. In some examples, different DCI messages (e.g., transmitted by different TRPs) may be used to schedule respective PUSCH messages to two or more TRPs, which may be referred to as multiple DCI (mDCI) mTRP operations. Further, the information indicated by the DCI message may vary in accordance with whether the PUSCH message is associated with a codebook (CB)-based PUSCH transmission or a non-CB-based PUSCH transmission. For example, for non-CB-based PUSCH, the DCI message may indicate a codepoint via an SRS resource set indicator field and an SRS resource indicator (SRI) field may indicate one or more SRS resources from one or more SRS resource sets indicated by the SRS resource set indicator field. The UE may use a quantity of the indicated SRS resource sets to select how many layers to use for the PUSCH message.

A UE may support, at a given time, one of various different configurations relating to how many layers the UE may use for the PUSCH message. In some scenarios, for example, if the UE may transmit up to (X1, X2) layers in a simultaneous transmission with multiple panels (STxMP) deployment (where the X1 layers may be associated with a first SRS resource set and the X2 layers may be associated with a second SRS resource set, simultaneously), the UE may transmit up to a greater of the X1 layers and the X2 layers in sTRP operation in accordance with a first configuration. In some other scenarios, if the UE may transmit up to (X1, X2) layers in an STxMP deployment, the UE may transmit up to X1+X2 layers in sTRP operation in accordance with a second configuration. While both configurations may be valid UE implementations, some systems may lack threshold rank configurations (e.g., maximum rank (maxRank) configurations) and DCI-interpretation rules according to which a UE may obtain information associated with a scheduled PUSCH message.

In some implementations, a UE and a network entity may support one or more configuration- or signaling-based mechanisms according to which the network entity may configure one or more maxRank values in accordance with the first configuration or the second configuration and according to which the UE may interpret one more DCI fields to identify, ascertain, or otherwise determine information associated with an sTRP or mTRP PUSCH message. For example, one or more control messages may indicate one or more control messages that indicate a quantity of a set of SRS resource sets, a quantity of one or more SRS resource indicator fields included in one or more control messages, and a set of parameters for multiple uplink shared channel messages. In some examples, the set of SRS resource sets may be configured for non-CB usage. The one or more control messages may indicate at least one threshold (e.g., maximum) rank value that is associated with uplink shared channel transmissions from the UE, the at least one maximum rank value being based on a threshold quantity of rank values supported by the UE.

Particular implementations of the subject matter described in this disclosure can be implemented to realize one or more of the following potential advantages. For example, in accordance with supporting an indication (which may be explicit or implicit based on how many maxRank values are configured or indicated for each SRS resource set) of the first configuration or the second configuration and one or more rules for interpretation of DCI fields may support more reliable indications of sTRP operation and mTRP operation while satisfying the maxRank constraints associated with the first configuration or the second configuration. In accordance with such greater reliability, the UE and the network entity may experience lower latency and more flexible or dynamic scheduling opportunities. Accordingly, the described techniques may enable the UE and the network entity to achieve relatively higher data rates, greater spectral efficiency, and facilitate greater system capacity, among other benefits.

Aspects of the disclosure are initially described in the context of wireless communications systems. Aspects of the disclosure are additionally illustrated by and described with reference to a signaling diagram, a multi-TRP transmission scheme, resource selection procedures, and a process flow. Aspects of the disclosure are further illustrated by and described with reference to apparatus diagrams, system diagrams, and flowcharts that relate to SRS indicator designs for non-CB-based communications.

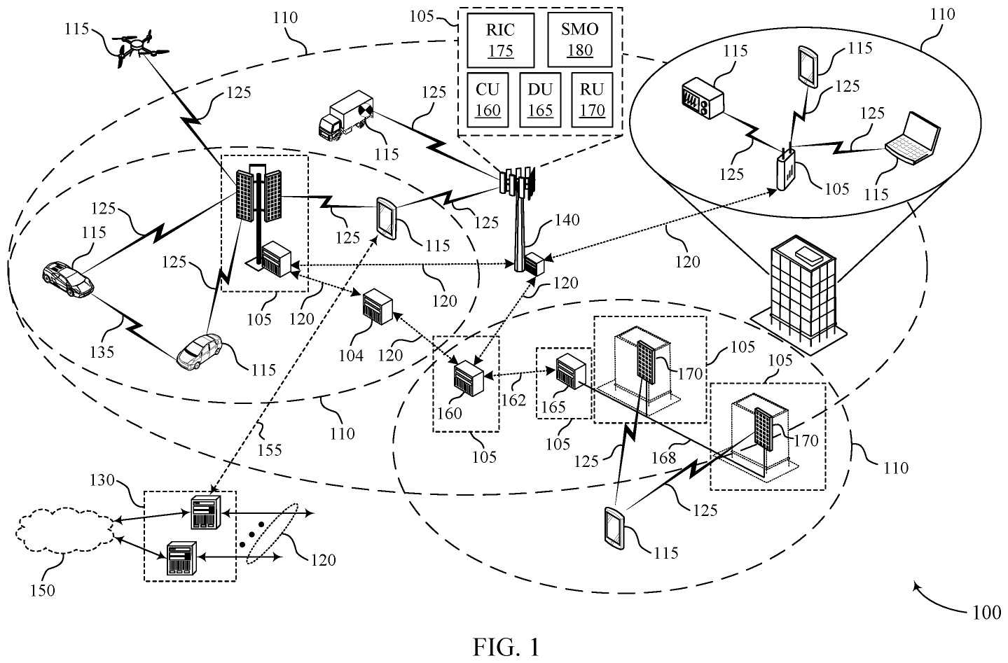

FIG. 1 illustrates an example of a wireless communications system 100 that supports SRS indicator designs for non-CB-based communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support SRS indicator designs for non-CB-based communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, such as the wireless communications system 100, a network entity 105 may dynamically schedule an uplink shared channel message, such as a PUSCH message, from a UE 115 via a DCI message. Such a DCI message may be referred to herein as a scheduling DCI, and may indicate information associated with the PUSCH message to be transmitted from the UE. Such information may include beamforming or panel information and may indicate whether a transmission is an sTRP or an mTRP transmission, and may be indicated or conveyed via an indication of one or more SRS resources. Further, the information indicated by the DCI message may vary in accordance with whether the PUSCH message is associated with a CB-based PUSCH transmission or a non-CB-based PUSCH transmission.

For example, for a CB-based PUSCH transmission, a UE 115 may be configured with one SRS resource set with “usage” set or configured to “codebook.” A maximum or upper limit of four SRS resources with the SRS resource set with “usage” set to “codebook” may be configured for a UE 115 and each SRS resource may be configured, such as RRC-configured, with a number of (e.g., quantity of) ports (such as via a nrofSRS-Ports parameter). Further, an SRI field in an uplink DCI (e.g., a DCI scheduling a PUSCH) may indicate one SRS resource. A quantity of ports configured for the indicated SRS resource may inform, indicate, imply, or otherwise assist a UE 115 in determining or selecting a quantity of antenna ports for a scheduled PUSCH. A UE 115 may transmit the scheduled PUSCH using a same spatial domain filter (e.g., a same uplink beam or directional configuration) as the indicated SRS resources. A UE 115 may determine or select a quantity of layers (e.g., a rank) and a transmit precoding matrix indicator (TPMI) (e.g., a precoder) for the scheduled PUSCH from or using a separate DCI field, such as a “precoding information and number of layers” field.

For a non-CB-based PUSCH transmission, a UE 115 may be configured with one SRS resource set with “usage” set or configured to “noncodebook.” A threshold (e.g., maximum) or upper limit of four SRS resources within the SRS resource set with “usage” set to “noncodebook” may be configured for a UE 115 and each SRS resource may have or otherwise be associated with one port. An SRI field in an uplink DCI (e.g., a DCI scheduling a PUSCH) may indicate one or multiple SRS resources. A number or quantity of indicated SRS resources may inform, indicate, imply, or otherwise assist a UE 115 in determining or selecting a rank (e.g., a number or quantity of layers) for a scheduled PUSCH and the UE 115 may transmit the scheduled PUSCH using a same precoder as well as a same spatial domain filter (e.g., precoder) as the indicated SRS resources.

For both CB-based PUSCH transmissions and non-CB-based PUSCH transmissions, a size of an SRI field may be a function of a quantity of SRS resources within the applicable SRS resource set. For example, a size of an SRI field for non-CB-based PUSCH transmissions may be defined in accordance with Table 1 if a higher layer parameter of txConfig is set equal to nonCodebook, where N_{SRS} may be a number or quantity of configured SRS resources in an SRS resource set configured by higher layer parameters srs-ResoureSetToAddModList, and associated with the higher layer parameter usage of value ‘nonCodeBook.’ The size of the SRI field may be └ log₂(Σₖ₌₁^{min{L}^{ₘₐₓ}^{,N}^{_{SRS}}^{}}(N_{SRS}))┘ (bits.

TABLE 1
SRI Indication for Non-CB-based PUSCH Transmission

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14 | 0, 1, 2, 3 |
| | | | | 15 | reserved |

Further, a UE 115 may support, at a given time, one of various different configurations relating to how many layers the UE 115 may use for the PUSCH message. In some scenarios, for example, if the UE 115 may transmit up to (X1, X2) layers in a simultaneous transmission with multiple panels (STxMP) deployment (where the X1 layers may be associated with a first SRS resource set and the X2 layers may be associated with a second SRS resource set, simultaneously), the UE 115 may transmit up to a greater of the X1 layers and the X2 layers in sTRP operation in accordance with a first configuration. In some other scenarios, if the UE 115 may transmit up to (X1, X2) layers in an STxMP deployment, the UE 115 may transmit up to X1+X2 layers in sTRP operation in accordance with a second configuration. While both configurations may be valid UE implementations, some systems may lack maxRank configurations and DCI-interpretation rules according to which a UE 115 may obtain information associated with a scheduled PUSCH message in compliance with one or both of the first configuration and the second configuration.

In some implementations, a UE 115 and a network entity 105 may support one or more configuration-based or signaling-based mechanisms according to which the network entity 105 may configure one or more maxRank values in accordance with the first configuration or the second configuration and according to which the UE 115 may interpret one more DCI fields to identify, ascertain, or otherwise determine information associated with a mTRP PUSCH message. The UE 115 may be configured with an interpretation of maxRank. Additionally, or alternatively, the UE 115 may be configured with one or more rules stating restriction to be implemented by the UE 115. Techniques of the present disclosure further provides for a configuration of SRS resource sets (and how many SRS resource sets can be configured) and a presence of the field in the DCI to indicate presence of an SRS resource set or presence of another overlapping PUSCH. In some examples, the UE 115 may use the techniques described herein to interpretate an SRS indicator field (which is either irrespective of overlap between PUSCHs or based on the overlap between PUSCHs). The configuration may be per-DCI format (separately configured for DCI format 0_1 versus 0_2), per-BWP, or per-component carrier.

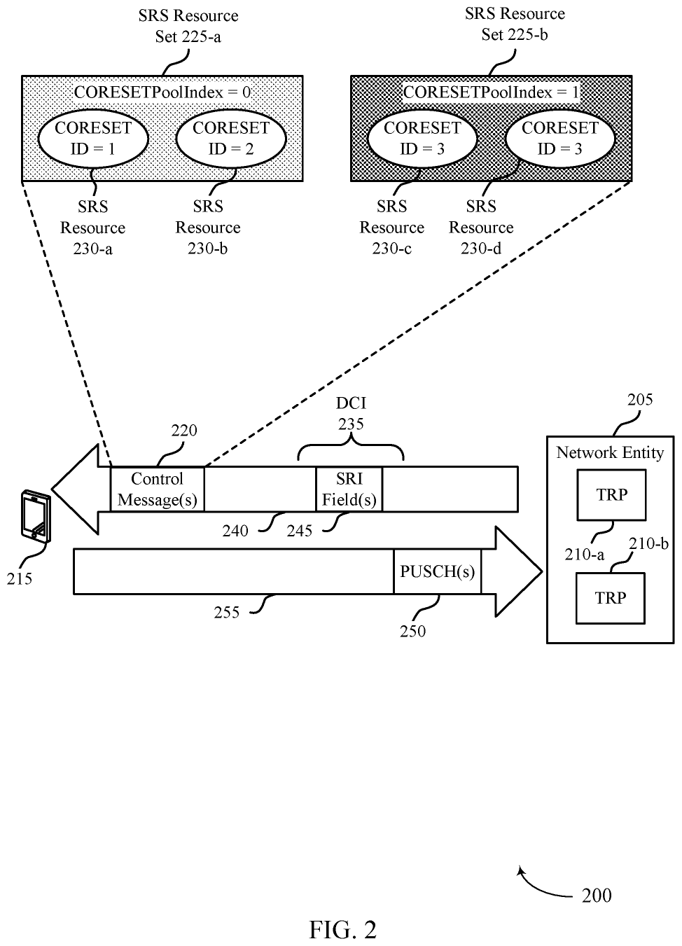

FIG. 2 illustrates an example of a wireless communications system 200 that supports SRS indicator designs for non-CB-based communications in accordance with one or more aspects of the present disclosure. The wireless communications system 200 may implement or be implemented to realize or facilitate aspects of the wireless communications system 100. For example, the wireless communications system 200 illustrates communication between a UE 215 and a network entity 205 via a TRP 210-a or a TRP 210-b, or both. The UE 215, the network entity 205, the TRP 210-a, and the TRP 210-b may be examples of corresponding devices illustrated by and described with reference to FIG. 1. In some implementations the UE 215 and the network entity 205 may support a dynamic switching between sTRP operation and mTRP operation at the UE 215 in accordance with specific configurations of one more maxRank values and an interpretation rule that the UE 115 may use when receiving, decoding, or interpreting scheduling DCI from the network entity 205.

The UE 215 and the network entity 205 may communicate via uplink communication link 255 and downlink communication link 240. The UE 215 and the network entity 205 may use the uplink communication link 255 and the downlink communication link 240 to transmit signaling to one or both of the TRP 210-a and the TRP 210-b and may receive signaling from one or both of the TRP 210-a and the TRP 210-b.

The UE 215 and the network entity 205 may communicate using PUSCHs in a TDM manner corresponding to different transmission parameters (such as different beam or spatial relation parameters, different power control parameters, or different precoding parameters, or any combination thereof) indicated to or configured at the UE 215. In some aspects, PUSCH repetitions may be scheduled by a single DCI may belong to two sets, where each set may have a respective precoding beam (e.g., a respective TCI state or spatial relation) or respective power control parameters, or any combination thereof. To facilitate such separate sets of PUSCH repetitions, the UE 215 and the network entity 205 may associate separate sets of PUSCH repetitions to separate SRS resource sets.

In some implementations, the UE 215 and the network entity 205 may support multi-DCI based multi-TRP transmission. In some examples, the UE 215 may receive the control message 220 including a first DCI (transmitted from TRP 210-a) that schedules a first PUSCH (to be transmitted to TRP 210-a). Additionally, the UE 215 may receive the control message 220 including a second DCI (transmitted from TRP 210-b) that schedules PUSCH2 (to be transmitted to TRP 210-b). The UE 215 may perform a TRP differentiation based on CORESETPoolIndex. For example, the control message 220 may include indication of a first SRS resource set 225-a and a second SRS resource set 225-b. The first SRS resource set 225-a may include SRS resource 230-a and SRS resource 230-b. The second SRS resource set 225-b may include SRS resource 230-c and SRS resource 230-d. The network entity 205 may configure each CORESET (e.g., a maximum of 5 CORESETs) with a value of CORESETPoolIndex. The value of CORESETPoolIndex can be 0 or 1. This groups the CORESETs in to two groups. A TRP may be associated with a CORESETPoolIndex value. For instance, CORESETPoolIndex=0 may be associated with TRP 210-a and the CORESETPoolIndex=1 may be associated TRP 210-b. In some examples, the UE 215 may be configured by higher layer parameter PDCCH-Config that includes two different values of CORESETPoolIndex in CORESETs for the active BWP of a serving cell.

In some wireless communications systems, PUSCHs may be TDM-ed in a component carrier or serving cell (across TRPs or CORESETPoolIndex values). Techniques depicted herein provide for SRI interpretation methods for multi-DCI based multi-TRP communications. The UE 215 may support, at a given time, one of various different configurations relating to how many layers the UE 215 may use for a PUSCH message. In some scenarios, for example, the UE 215 may transmit up to (X1, X2) layers in a simultaneous transmission with multiple panels (STxMP) deployment when two PUSCHs are time-domain overlapping (where the X1 layers may be associated with a first SRS resource set and the X2 layers may be associated with a second SRS resource set, simultaneously). The UE 215 may transmit up to a greater of the X1 layers and the X2 layers in sTRP operation in accordance with a first configuration. In some other scenarios, if the UE 215 may transmit up to (X1, X2) layers in an STxMP deployment, the UE 215 may transmit up to X1+X2 layers in sTRP operation in accordance with a second configuration. In dynamic switching between STxMP operation and sTRP operation, in a first case, if the UE 215 transmits up to (X1,X2) layers when two PUSCHs are time-domain overlapping (in STxMP), then the UE 215 may transmit up to a threshold (e.g., a maximum) of layers ((X1, X2) layers) when only one PUSCH is scheduled (e.g., for sTRP). Additionally, in a second case, if UE 215 can transmit up to (X1, X2) layers in STxMP, then the UE 215 may transmit up to X1+X2 layers in sTRP operation. In some examples, X1 and X2 may be equal to 1 or 2. Both cases may be valid because they correspond to different UE RF or baseband implementations. In examples of a non-ideal backhaul between two TRPs 210, even when UE 215 is capable of supporting the second case, the scheduling may be based on the first case. In some examples, TRP 210-b may not be aware whether the TRP 210-a dynamically schedules a first PUSCH in a given slot. Hence, the UE 215 may assume the case that a PUSCH has been scheduled. In such cases, the TRP 210-b cannot take advantage of using a higher quantity of layers for a second PUSCH when a first PUSCH is actually not scheduled. The second case may be applicable when the UE 215 is capable of using an increased quantity of layers and when two TRPs coordinate dynamically (e.g., based at least on whether the other TRP will be scheduling an overlapping PUSCH). Using techniques described herein, the UE 215 may use one or more rules to interpret the size and the indication of SRI field in the DCI for both STxMP and sTRP scheduling. The SRI field interpretation may be independent of whether there is another PUSCH overlapping in time. The present disclosure provide for restrictions and rules to ensure that a capability of the UE 215 is not exceeded in case of overlapping PUSCHs. Additionally, the present disclosure provide for SRI field interpretation to be a function of whether there is another overlapping PUSCH, and one or more additional enhancements.

For Non-CB-based multi-DCI based PUSCH, the network entity 205 may configure maxRank configurations for both cases. According to aspects depicted herein, the UE 215 may receive one or more control messages 220 that indicate a quantity of a set of SRS resource sets, a quantity of one or more SRS resource indicator fields included in one or more control messages 220, and a set of parameters for multiple uplink shared channel messages. In some examples, the set of SRS resource sets may be configured for non-CB usage. The one or more control messages 220 may indicate at least one threshold (e.g., maximum) rank value (maxRank value) that is associated with uplink shared channel transmissions (PUSCH 250 transmission) from the UE 215, the at least one maximum rank value being based on a threshold quantity of rank values supported by the UE 215. The UE 215 may then receive a message including DCI 235 that schedules at least one uplink shared channel message, the DCI message including the one or more SRS resource indicator fields 245. The UE 215 may be able to use the techniques of the present disclosure to interpret the SRS resource indicator fields. For instance, the UE 215 may interpret the one or more SRS resource indicator fields 245 based on a quantity of the at least one maximum rank value and whether at least a first uplink shared channel message (first PUSCH 250) and a second uplink shared channel message (second PUSCH 250) overlap at least partially in a time domain. The UE 215 may then transmit the at least one uplink shared channel message (either the first PUSCH 250 or the second PUSCH 250 or both) in accordance with interpreting the one or more SRS resource indicator fields 245.

In some examples, the UE 215 may receive an indication of a configuration associated with the at least one maximum rank value. The configuration may be either a first configuration or a second configuration. In some examples, the first configuration may indicate that, if the at least one uplink shared channel message is associated with a single SRS resource set, a maximum rank value associated with the uplink shared channel message is equal to a larger of a first maximum rank value associated with a first SRS resource set 225-a and a second maximum rank value associated with a second SRS resource set 225-b. The second configuration may indicate that, if the at least one uplink shared channel message is associated with the single SRS resource set, the maximum rank value associated with the uplink shared channel message is equal to a summation of the first maximum rank value associated with the first SRS resource set 225-a and the second maximum rank value associated with the second SRS resource set 225-b.

In the first case (where the UE 215 may transmit up to (X1,X2) layers when two PUSCHs are time-domain overlapping and may transmit a maximum of (X1,X2) layers when only one PUSCH is scheduled), the UE 215 may receive an indication of a respective maximum rank value for each respective SRS resource set of the set of SRS resource sets configured at the UE 215. That is, the value of maxRank may be RRC-configured, which corresponds to quantity of layers of a PUSCH associated with a first CORESETPoolIndex value (e.g., CORESETPoolIndex=0 or CORESETPoolIndex=1) irrespective of whether there is another time-overlapping PUSCH associated with a second CORESETPoolIndex value in the same component carrier (in an STxMP mode) or in different component carriers (in an sTRP mode). The configuration of maxRank may be per CORESETPoolIndex value or SRS resource set. For example, the configuration of maxRank may be X1 (for first CORESETPoolIndex value or the first SRS resource set 225-a) may not be the same as X2 (for the second CORESETPoolIndex value or the second SRS resource set 225-b). For example, the UE 215 may receive an indication of a first maxRank value corresponding to a quantity of layers of the first uplink shared channel message associated with a first CORESETPoolIndex value, where the second uplink shared channel message associated with a second CORESETPoolIndex value partially overlaps with the first uplink shared channel message. Alternatively, the UE 215 may receive the indication of the first maxRank value corresponding to the quantity of layers of the first uplink shared channel message associated with the first CORESETPoolIndex value, where the second uplink shared channel message associated with the second CORESETPoolIndex value is absent. In such cases, the UE 215 may receive a second indication of a second maxRank value corresponding to the quantity of layers of the second uplink shared channel message associated with the second CORESETPoolIndex value. The first maxRank value and the second maxRank value may be the same or different.

In some examples, the configuration of maxRank may be per-DCI format (separately configured for DCI format 0_1 versus DCI format 0_2), or per-BWP, or per-component carrier. That is, the first maxRank value and the second maxRank value may be configured in accordance with at least one of a control message format, a BWP, a component carrier, or a combination thereof. In some cases, the interpretation of an SRI field of a DCI scheduling a first PUSCH may not be a function of whether there is a second overlapping PUSCH. Additionally, or alternatively, each PUSCH may be scheduled with a quantity of layers up to maxRank irrespective of whether there is another overlapping PUSCH.

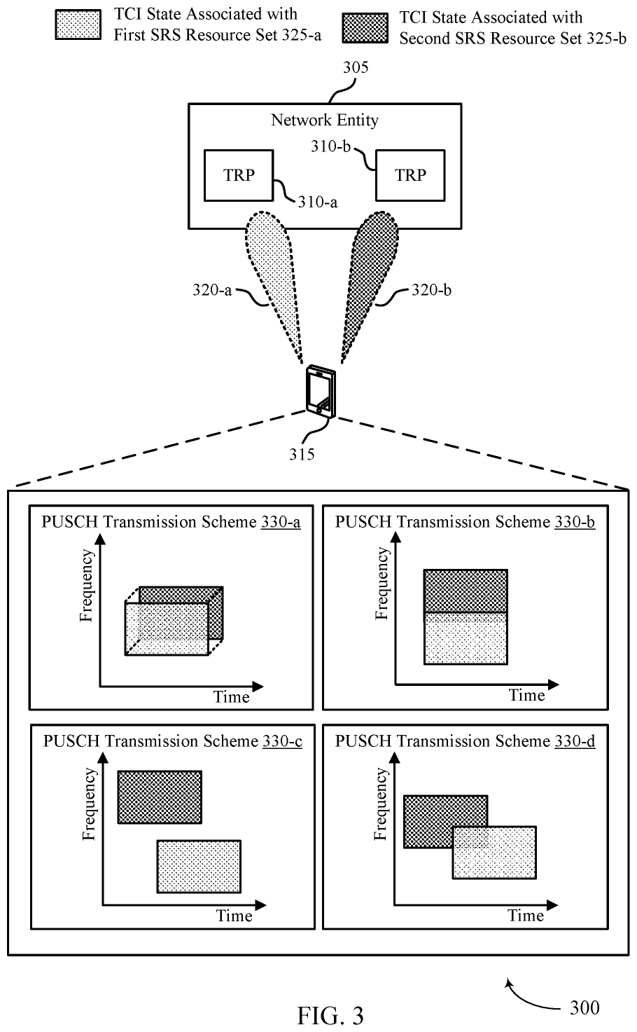

FIG. 3 illustrates an example of a multi-TRP transmission scheme 300 that supports SRS indicator designs for non-CB-based communications in accordance with one or more aspects of the present disclosure. The multi-TRP transmission scheme 300 may implement or be implemented to realize or facilitate aspects of the wireless communications system 100 or the wireless communications system 200. For example, the multi-TRP transmission scheme 300 illustrate communication between a UE 315 and a network entity 305 associated with a TRP 310-a and a TRP 310-b, which may be examples of corresponding devices as illustrated by and described with reference to FIGS. 1 and 2.

In some examples, the multi-TRP transmission scheme 300 may support a PUSCH transmission from a single UE to multiple TRPs 310 of a network entity 305 via different directional beams 320 (including directional beam 320-a and directional beam 320-b), where the different directional beams 320 may be associated with different SRS resource sets, different transmission configuration indicator (TCI) states, different layers, different PUSCH ports, or different panels of the UE 315, or any combination thereof. The multi-TRP transmission scheme 300 may illustrate an example of multiple PUSCHs overlapping at least partially in time. The multi-TRP transmission scheme 300 may illustrate examples of multiple PUSCH transmission schemes (e.g., PUSCH transmission scheme 330-a, PUSCH transmission scheme 330-b, PUSCH transmission scheme 330-c, and PUSCH transmission scheme 330-d). As depicted in the example of FIG. 3, the UE 315 and the network entity 305 may support multi-DCI based multi-TRP framework, where the two PUSCHs are associated with different CoresetPoolIndex values. The first PUSCH (associated with CoresetPoolIndex value 0) may be associated with the first SRS resource set 325-a, and may be transmitted using a first beam or TCI state or power control parameters or precoder. Similarly, the second PUSCH (associated with CoresetPoolIndex value 1) may be associated with the second SRS resource set 325-b, and may be transmitted using a second beam or TCI state or power control parameters or precoder.

In some examples, two different PUSCHs in the same serving cell or component carrier may partially or fully overlap in at least time domain. The PUSCHs may overlap or may not overlap in frequency domain. In the example of the PUSCH transmission scheme 330-a, the first PUSCH and the second PUSCH may overlap both in time and in frequency. In the example of the PUSCH transmission scheme 330-b, the first PUSCH and the second PUSCH overlap in time but not in frequency. In the example of the PUSCH transmission scheme 330-c, the first PUSCH and the second PUSCH partially overlap in time but do not overlap in frequency. In the example of the PUSCH transmission scheme 330-a, the first PUSCH and the second PUSCH partially overlap in time and frequency. The UE 315 may interpret a control message in accordance with the techniques depicted herein and may transmit an uplink message using at least one of the PUSCH transmission scheme 330-a, the PUSCH transmission scheme 330-b, the PUSCH transmission scheme 330-c, and the PUSCH transmission scheme 330-d.

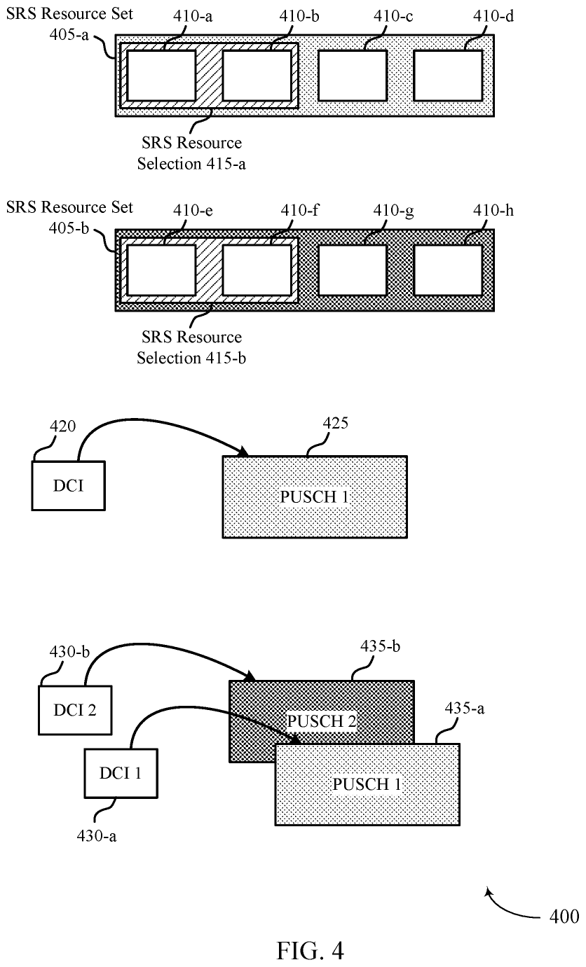

FIG. 4 illustrates an example of a resource selection procedure 400 that supports SRS indicator designs for non-CB-based communications in accordance with one or more aspects of the present disclosure. The resource selection procedure 400 may implement or be implemented to realize or facilitate aspects of the wireless communications system 100, the wireless communications system 200, the multi-TRP transmission scheme 300.

In some implementations, the UE 115 may employ the resource selection procedure 400 to select a subset of one or more SRS resources 410 from one or more SRS resource sets 405. For example, an SRS resource set 405-a may include an SRS resource 410-a, an SRS resource 410-b, an SRS resource 410-c, and an SRS resource 410-d and the UE 115 may perform an SRS resource selection 415-a to select the SRS resource 410-a and the SRS resource 410-b. Further, an SRS resource set 405-b may include an SRS resource 410-e, an SRS resource 410-f, an SRS resource 410-g, and an SRS resource 410-h and the UE 115 may perform an SRS resource selection 415-b to select the SRS resource 410-e and the SRS resource 410-f.

Generally, the UE 115 may employ one of two alternatives to select SRS resources 410 from one or more SRS resource sets 405. In some implementations, any of the SRS resources 410 of an SRS resource set 405 may be selected based on sTRP or STxMP operation. In some implementations, a threshold quantity (e.g., a maximum quantity) that may be selected (corresponding to maxRank) may be different for sTRP versus STxMP. In some other implementations, different amounts of SRS resources may be selected depending on whether the UE 115 is in an sTRP mode vs. an STxMP mode.

As depicted in the example of FIG. 4, a DCI may include an SRI field. The UE 115 may interpret the SRI field in accordance with one or more rules. For example, the DCI 420 may include an SRI field indicating a set of SRS resources associated with CORESETPoolIndex value 0. For instance, the DCI 420 may indicate SRS resources 410-a and 410-b for transmitting the PUSCH 425 in case there is no overlapping PUSCH. In another example, PUSCH 435-a may at least partially overlap in the time domain with PUSCH 435-b. The DCI 430-a may include an SRI field indicating a set of SRS resources associated with CORESETPoolIndex value 0 and the DCI 430-b may include an SRI field indicating a set of SRS resources associated with CORESETPoolIndex value 1. For instance, the DCI 430-a may indicate one or both of the SRS resources 410-a and 410-b for transmitting the PUSCH 435-a and the DCI 430-b may indicate one or both of the SRS resources 410-e and 410-f for transmitting the PUSCH 435-b.

In some examples, a UE 115 may be configured with a rule for interpreting an SRI field. The UE 115 may be configured (via an RRC message) a maxRank value X irrespective of whether multiple PUSCHs overlap at least partially in time. The interpretation of the SRI field of the DCI may be based on the configured maxRank value (maxRank=X) and the corresponding SRS resource set (associated with the CORESETPoolIndex of the CORESET in which the DCI is received). When there is no overlapping PUSCH, the network entity 105 may indicate a maxRank value (up to maxRank=X) for a quantity of layers of a PUSCH. When there is an overlapping PUSCH associated with the other CORESETPoolIndex value or another SRS resource set, the UE 115 may transmit the PUSCH in accordance with one or more rules.

The one or more rules may state (e.g., indicate, dictate, control) that the UE may not expect to be indicated with more than X1 SRS resources (>X1 layers) for a PUSCH associated with a first CORESETPoolIndex value if another PUSCH (associated with a second CORESETPoolIndex value) with time-domain overlap is scheduled in the same component carrier. Additionally, or alternatively, the one or more rules may state that the UE 115 may not expect to be indicated with more than X2 SRS resources (>X2 layers) for a PUSCH associated with a second CORESETPoolIndex value if another PUSCH (associated with a first CORESETPoolIndex value) with time-domain overlap is scheduled in the same component carrier. For example, the UE 115 may transmit at least one uplink shared channel message in accordance with one or more rules associated with a quantity of a set of SRS resources (e.g., SRS resource sets 405). In some examples, the one or more rules state that a first threshold (e.g., a first maximum) quantity of SRS resources is to be indicated for the first uplink shared channel message (PUSCH 1) associated with a first CORESET index value (e.g., CORESETPoolIndex), where the second uplink shared channel message (PUSCH 2) associated with a second CORESET index value (e.g., CORESETPoolIndex) partially overlaps with the first uplink shared channel message in a common component carrier. The one or more rules state that a second threshold (e.g., a second maximum) quantity of the SRS resources is to be indicated for the second uplink shared channel message associated with the second CORESET index value.

In some examples, the X1 SRS resources (e.g., SRS resources selected from SRS resource selection 415-a) and the X2 SRS resources (e.g., SRS resources selected from SRS resource selection 415-b) may be configured using an RRC or may be indicated by UE capability signaling, or may be based on a fixed rule. In some examples, the one or more rules may state that a value of maxRank=X is less than or equal to X1+X2. In case of X1=X2, the one or more rules may state that X1=X2=X/2 (e.g., according to a fixed rule). In some examples, the UE 115 may receive a control message indicating the first maximum quantity of the SRS resources and the second maximum quantity of the SRS resources. A summation of the first maximum quantity of the SRS resources and the second maximum quantity of the SRS resources may be less than or equal to the at least one maximum rank value.

In some examples, the first SRS resource set 405-a may have N1 resources, and the second SRS resource set 405-b may have N2 resources. When there is no overlapping PUSCH, one or more rules may state that the network entity 105 may indicate any of one or more (and up to maxRank=X) of the N1 SRS resources for a quantity of layers of a PUSCH associated with the first CORESETPoolIndex value. Additionally, or alternatively, the network entity 105 may indicate any of one or more (and up to maxRank=X) of the N2 SRS resources for a quantity of layers of a PUSCH associated with the second CORESETPoolIndex value. When there is an overlapping PUSCH associated with the other CORESETPoolIndex value or another SRS resource set, then the one or more rules may state that the network entity 105 may indicate to the UE 115, one or more (and up to X1) of a first M1 (M1<N1) SRS resources of the first SRS resource set 405-a for a PUSCH associated with a first CORESETPoolIndex value if another PUSCH (associated with a second CORESETPoolIndex value) with time-domain overlap is scheduled in the same component carrier. Additionally, or alternatively, the one or more rules may state that the network entity 105 may indicate, to the UE 115, one or more (and up to X2) of the first M2 (M2<N2) SRS resources of the second SRS resource set for a PUSCH associated with a second CORESETPoolIndex value if another PUSCH (associated with a first CORESETPoolIndex value) with time-domain overlap is scheduled in the same component carrier.

For example, the UE 115 may transmit at least one uplink shared channel message in accordance with one or more rules associated with the set of SRS resource sets. In some instances, the one or more rules state that a first maximum quantity of SRS resources including a subset of the first SRS resource set is to be indicated for the first uplink shared channel message (PUSCH 1) associated with a first CORESET index value. In some cases, the second uplink shared channel message (PUSCH 2) associated with a second CORESET index value partially overlaps with the first uplink shared channel message in a common component carrier. Additionally, or alternatively, the one or more rules may state that a second maximum quantity of SRS resources including a subset of the second SRS resource set is to be indicated for the second uplink shared channel message associated with the second CORESET index value.

The values of M1 or M2 may be configured using an RRC signaling or may be indicated by UE capability signaling, or be based on a fixed rule (the fixed rule can be M1=N1/2 and M2=N2/2). In some examples, the UE 115 may receive a control message indicating the first maximum quantity of the SRS resources and the second maximum quantity of the SRS resources. Additionally, or alternatively, the UE 115 may transmit, via a capability report, information indicating the first maximum quantity of the SRS resources and the second maximum quantity of the SRS resources. The first maximum quantity of the SRS resources may be equal to half of the first SRS resource set and the second maximum quantity of the SRS resources may be equal to half of the second SRS resource set.

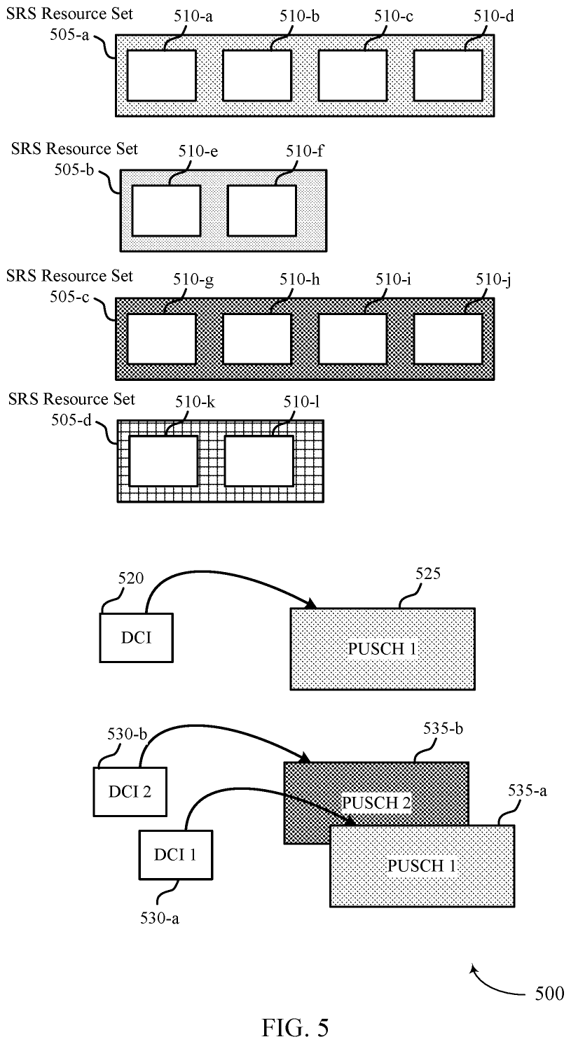

FIG. 5 illustrates an example of a resource selection procedure 500 that supports SRS indicator designs for non-CB-based communications in accordance with one or more aspects of the present disclosure. The resource selection procedure 500 may implement or be implemented to realize or facilitate aspects of the wireless communications system 100, the wireless communications system 200, the multi-TRP transmission scheme 300.

In some implementations, the UE 115 may employ the resource selection procedure 500 to select a subset of one or more SRS resources 510 from one or more SRS resource sets 505. For example, an SRS resource set 505-a may include an SRS resource 510-a, an SRS resource 510-b, an SRS resource 510-c, and an SRS resource 510-d. Further, an SRS resource set 505-b may include an SRS resource 510-e and an SRS resource 510-f. An SRS resource set 505-c may include an SRS resource 510-g, an SRS resource 510-h, an SRS resource 510-i, and an SRS resource 510-j. Further, an SRS resource set 505-d may include an SRS resource 510-k and an SRS resource 510-1.

As depicted in the example of FIG. 5, a DCI may include an SRI field. The UE 115 may interpret the SRI field in accordance with one or more rules. For example, the DCI 520 may include an SRI field indicating a set of SRS resources associated with CORESETPoolIndex value 0. For instance, the DCI 520 may indicate SRS resources from the SRS resource set 505-a for transmitting the PUSCH 525 in case there is no overlapping PUSCH. In another example, PUSCH 535-a may at least partially overlap in the time domain with PUSCH 535-b. The DCI 530-a may include a new field, which in combination with the SRI field may indicate a set of SRS resources from the SRS resource set 505-c for transmitting the PUSCH 535-a. Additionally, or alternatively, the DCI 530-b may include a new field, which in combination with the SRI field may indicate a set of SRS resources from the SRS resource set 505-d for transmitting the PUSCH 535-b.

In some examples, the interpretation of SRI field of a DCI scheduling a first PUSCH may be a function of whether there is a second overlapping PUSCH. In some examples, the network entity 105 may configure separate SRS resource sets (a third and a fourth SRS resource sets) specific to when it intends to schedule overlapping PUSCHs. Separate SRS resource sets may be used for separate SRS precoding depending on whether the PUSCHs at least partially overlap in time. A first DCI may schedule a first PUSCH (PUSCH 1) associated with CORESETPoolIndex value 0 and a second DCI may schedule a second PUSCH (PUSCH 2) associated with CORESETPoolIndex value 1. If the UE 115 fails to receive the second DCI, then the UE 115 may inadvertently interpret the SRI field (and hence quantity of layers) of the first DCI incorrectly (SRS resources are selected from first SRS resource set rather than third SRS resource set). In such cases, techniques for the present disclosure provide separate SRS resource sets for different cases of PUSCH overlap. A first SRS resource set may be associated with CORESETPoolIndex value 0 when there is no other overlapping PUSCH. A second SRS resource set may be associated with CORESETPoolIndex value 1 when there is no other overlapping PUSCH. A third SRS resource set may be associated with CORESETPoolIndex value 0 when there is another overlapping PUSCH. A fourth SRS resource set may be associated with CORESETPoolIndex value 1 when there is another overlapping PUSCH. The first and third SRS resource sets and the second and fourth SRS resource sets may be restricted to be configured with the same associated CSI-RS resource and the same power control parameters.

In some examples, the UE 115 may receive an indication of a first SRS resource set of the set of SRS resource sets for the first uplink shared channel message associated with a first CORESET index value, where the second uplink shared channel message associated with a second CORESET index value is absent. Additionally, or alternatively, the UE 115 may receive the indication of a second SRS resource set of the set of SRS resource sets for the second uplink shared channel message associated with the second CORESET index value, where the first uplink shared channel message associated with the first CORESET index value is absent. Additionally, or alternatively, the UE 115 may receive the indication of a third SRS resource set of the set of SRS resource sets for the first uplink shared channel message associated with the first CORESET index value, where the second uplink shared channel message associated with the second CORESET index value partially overlaps with the first uplink shared channel message. Additionally, or alternatively, the UE 115 may receive the indication of a fourth SRS resource set of the set of SRS resource sets for the second uplink shared channel message associated with the second CORESET index value, where the first uplink shared channel message associated with the first CORESET index value partially overlaps with the second uplink shared channel message. The first SRS resource set and the third SRS resource set may be associated with a common channel state information resource set and a common set of power control parameters. In some examples, the second SRS resource set and the fourth SRS resource set may be associated with a common channel state information resource set and a common set of power control parameters.

In some examples, the third SRS resource set may include same or smaller quantity of SRS resources compared to the quantity of SRS resources of the first SRS resource set. In some examples, the fourth SRS resource set may include same or smaller quantity of SRS resources compared to the numb quantity er of SRS resources of the second SRS resource set. That is, a quantity of resources in the third SRS resource set may be less than a quantity of resources in the first SRS resource set and a quantity of resources in the fourth SRS resource set is less than a quantity of resources in the second SRS resource set.

According to one or more aspects, the UE 115 may determine which SRS resource sets are the first set, which SRS resource sets are the second set, which SRS resource sets are the third set, and which SRS resource sets are the fourth set. Additionally, or alternatively, the UE 115 may determine the association between each SRS resource set and a corresponding CORESETPoolIndex value based on an explicit RRC configuration or implicitly based on SRS resource set identifier.

A first value of maxRank (X) may be RRC-configured applicable when there are no other overlapping PUSCH. A second one or more values of maxRank (X1/X2) may be RRC-configured in case of overlapping PUSCHs. The configuration of the second one or more maxRank (X1, X2) may be per SRS resource set. In this case, X1 (for first SRS resource set) may not be the same as X2 (for second SRS resource set). Additionally, or alternatively, the configuration of the second one or more maxRank (X1, X2) may be per DCI format (separately configured for DCI format 0_1 versus DCI format 0_2), or per BWP, or per component carrier. For example, the UE 115 may receive an indication of a first maximum rank value corresponding to the first uplink shared channel message associated with a first CORESET index value, where the second uplink shared channel message associated with a second CORESET index value is absent. In some examples, the UE 115 may receive the indication of a second maximum rank value corresponding to the first uplink shared channel message associated with the first CORESET index value and a third maximum rank value corresponding to the second uplink shared channel message associated with the second CORESET index value, where the second uplink shared channel message associated with the second control resource set index value partially overlaps with the first uplink shared channel message. In such cases, one or more rules may indicate that X is less than or equal to X1+X2 (or X≤2X′ when X1=X2=X′). For example, the second maximum rank value and the third maximum rank value may be the same or different. The second maximum rank value and the third maximum rank value may be configured in accordance with at least one of a control message format, a bandwidth part, a component carrier, or a combination thereof. In some cases, a summation of the second maximum rank value and the third maximum rank value may be less than or equal to the first maximum rank value.

According to one or more aspects, the DCI may include a field indicating an SRS resource set or presence of another overlapping PUSCH. Such a field may make the DCI self-contained irrespective of whether the other DCI is detected. In some examples, 1 bit in the DCI indicates which of the two SRS resource sets associated with the CORESETPoolIndex value of the CORESET in which the DCI is detected is to be assumed. In some examples, the one or more rules may indicate how the UE 115 may interpret the field in the DCI to select between first vs third SRS resource set (in case of CORESETPoolIndex value 0) or between second vs fourth SRS resource set (in case of CORESETPoolIndex value 1). Additionally, or alternatively, one bit in the DCI may indicate whether another overlapping PUSCH is scheduled in the same component carrier. In some examples, the one or more rules may state that if the value of the new field is 0 and the UE 115 receives the DCI in a CORESET with CORESETPoolIndex value 0, then the UE may assume the first SRS resource set. In some examples, the one or more rules may state that if the value of the new field is 1 and the UE 115 receives the DCI in a CORESET with CORESETPoolIndex value 0, then the UE may assume the third SRS resource set. In some examples, the one or more rules may state that if the value of the new field is 0 and the UE 115 receives the DCI in a CORESET with CORESETPoolIndex value 1, then the UE may assume the second SRS resource set. In some examples, the one or more rules may state that if the value of the new field is 1 and the UE 115 receives the DCI in a CORESET with CORESETPoolIndex value 1, then the UE may assume the fourth SRS resource set.

The UE 115 may determine an SRS resource set based on the field in the DCI, the CORESETPoolIndex value and the corresponding maxRank value (configured based on X is used for first or second SRS resource sets, X1 for third SRS resource set, X2 for fourth SRS resource sets). In some examples, the UE 115 may receive a control message including an indication of SRS resource set selection, The UE 115 may interpret the one or more SRS resource indicator fields based on the indication of SRS resource set selection and a first CORESET index value or a second CORESET index value. In some examples, the SRI field may indicate up to maxRank SRS resources from the determined SRS resource set. The size of the SRI field of the DCI may be based on the possibilities discussed herein (which corresponds to the case that either the first or the second SRS resource set is determined).

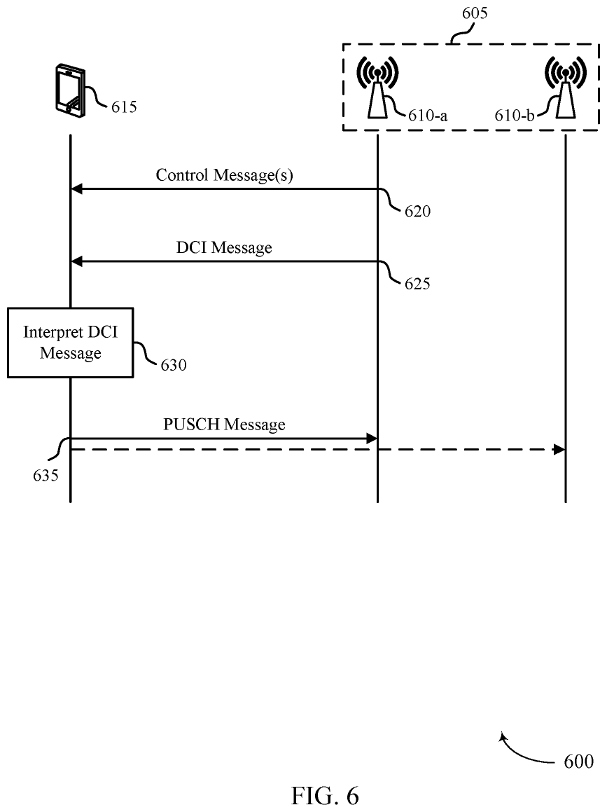

FIG. 6 illustrates an example of a process flow 600 that supports SRS indicator designs for non-CB-based communications in accordance with one or more aspects of the present disclosure. The process flow 600 may implement or be implemented to realize or facilitate aspects of the wireless communications system 100, the wireless communications system 200, the multi-TRP transmission scheme 300, the resource selection procedure 400, or the resource selection procedure 500. For example, the process flow 600 illustrates communication between a UE 615 and a network entity 605 associated with a TRP 610-a and a TRP 610-b, which may be examples of corresponding devices as illustrated by and described with reference to FIGS. 1 and 2.

In the following description of the process flow 600, the operations may be performed (such as reported or provided) in a different order than the order shown, or the operations performed by the example devices may be performed in different orders or at different times. For example, specific operations also may be left out of the process flow 600, or other operations may be added to the process flow 600. Further, although some operations or signaling may be shown to occur at different times for discussion purposes, these operations may actually occur at the same time. Further, the signaling illustrated by and described with reference to FIG. 6 may include one or more UCI messages, one or more DCI messages, RRC signaling, one or more MAC-CEs, or one or more data messages, or any combination thereof.

At 620, a UE 115 may receive to a UE 615 one or more control messages. The one or more control messages may indicate quantity of a set of SRS resource sets, a quantity of one or more SRS resource indicator fields included in one or more control messages, and a set of parameters for multiple uplink shared channel messages, where the set of SRS resource sets are configured for non-CB usage, and at least one maximum rank value that is associated with uplink shared channel transmissions from the UE, the at least one maximum rank value being based on a threshold quantity of rank values supported by the UE.

At 625, the UE 115 may receive a DCI message that schedules an uplink shared channel message. For example, the UE 115 may receive a message including DCI that schedules at least one uplink shared channel message, the DCI message including the one or more SRS resource indicator fields.

At 630, in some aspects of the present disclosure, the UE 115 may interpret the one or more SRS resource indicator fields based on a quantity of the at least one maximum rank value (e.g., and whether at least a first uplink shared channel message and a second uplink shared channel message overlap at least partially in a time domain).

At 635, the UE 115 may transmit the at least one uplink shared channel message in accordance with interpreting the one or more SRS resource indicator fields.

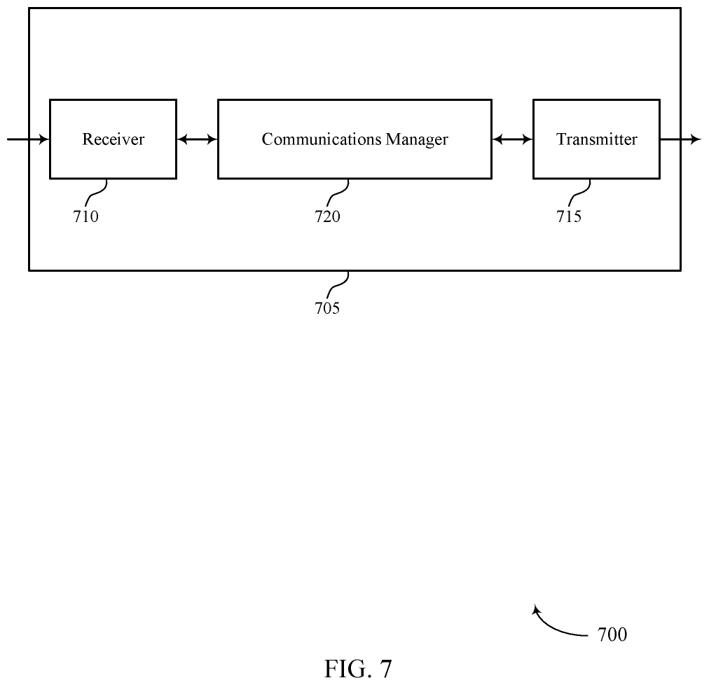

FIG. 7 shows a block diagram 700 of a device 705 that supports SRS indicator designs for non-CB-based communications in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to SRS indicator designs for non-CB-based communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SRS indicator designs for non-CB-based communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of SRS indicator designs for non-CB-based communications as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. The more control messages may indicate at least one maximum rank value that being associated with uplink shared channel transmissions from the UE, the at least one maximum rank value being based on a threshold quantity of rank values supported by the UE.

The communications manager 720 may be configured as or otherwise support a means for receiving a message including DCI that schedules at least one uplink shared channel message, the DCI message including the one or more SRS resource indicator fields. The communications manager 720 may be configured as or otherwise support a means for interpreting the one or more SRS resource indicator fields based on a quantity of the at least one maximum rank value (e.g., and whether at least a first uplink shared channel message and a second uplink shared channel message overlap at least partially in a time domain). The communications manager 720 may be configured as or otherwise support a means for transmitting the at least one uplink shared channel message in accordance with interpreting the one or more SRS resource indicator fields.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, and more efficient utilization of communication resources.

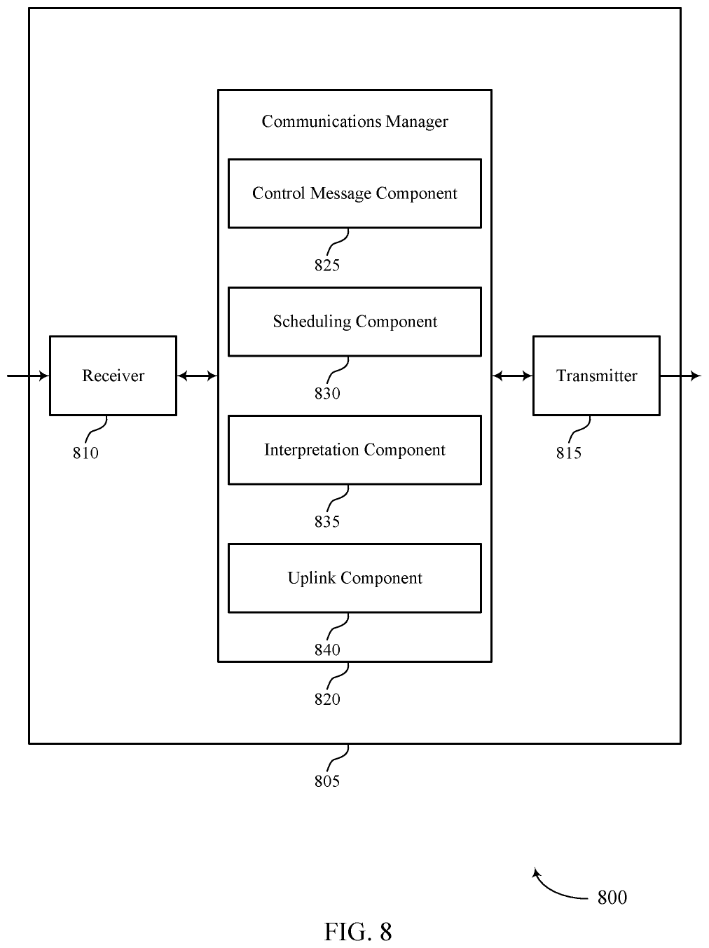

FIG. 8 shows a block diagram 800 of a device 805 that supports SRS indicator designs for non-CB-based communications in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to SRS indicator designs for non-CB-based communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SRS indicator designs for non-CB-based communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of SRS indicator designs for non-CB-based communications as described herein. For example, the communications manager 820 may include a control message component 825, a scheduling component 830, an interpretation component 835, an uplink component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control message component 825 may be configured as or otherwise support a means for receiving one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. The one or more control messages may indicate at least one maximum rank value that is associated with uplink shared channel transmissions from the UE, the at least one maximum rank value being based on a threshold quantity of rank values supported by the UE.

The scheduling component 830 may be configured as or otherwise support a means for receiving a message including DCI that schedules at least one uplink shared channel message, the DCI message including the one or more SRS resource indicator fields. The interpretation component 835 may be configured as or otherwise support a means for interpreting the one or more SRS resource indicator fields based on a quantity of the at least one maximum rank value (e.g., and whether at least a first uplink shared channel message and a second uplink shared channel message overlap at least partially in a time domain). The uplink component 840 may be configured as or otherwise support a means for transmitting the at least one uplink shared channel message in accordance with interpreting the one or more SRS resource indicator fields.

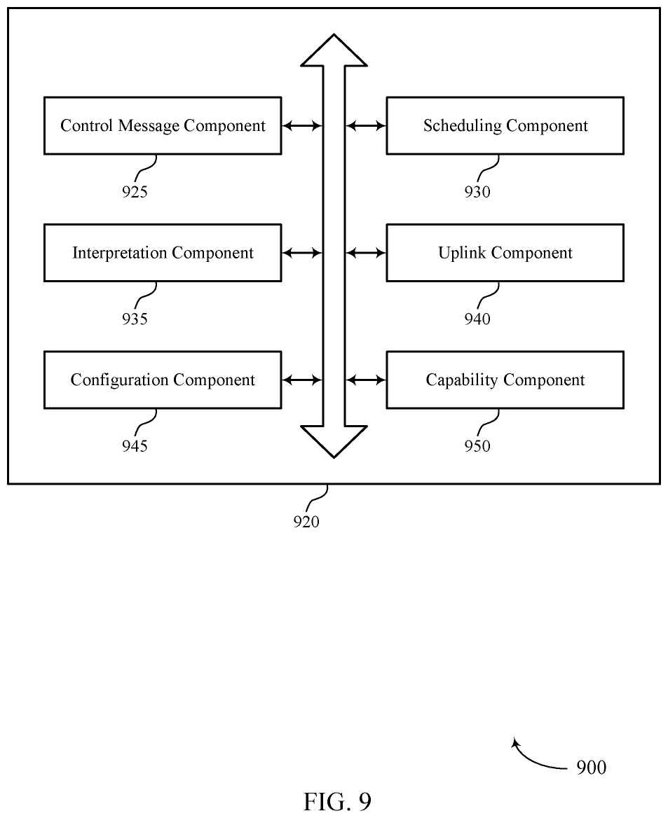

FIG. 9 shows a block diagram 900 of a communications manager 920 that supports SRS indicator designs for non-CB-based communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of SRS indicator designs for non-CB-based communications as described herein. For example, the communications manager 920 may include a control message component 925, a scheduling component 930, an interpretation component 935, an uplink component 940, a configuration component 945, a capability component 950, or any combination thereof. Each of these components may communicate, directly or indirectly, with one another (e.g., via one or more buses).

The communications manager 920 may support wireless communication at a UE in accordance with examples as disclosed herein. The control message component 925 may be configured as or otherwise support a means for receiving one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. In some examples, the one or more control messages may indicate for at least one maximum rank value that is associated with uplink shared channel transmissions from the UE, the at least one maximum rank value being based on a threshold quantity of rank values supported by the UE.

The scheduling component 930 may be configured as or otherwise support a means for receiving a message including DCI that schedules at least one uplink shared channel message, the DCI message including the one or more SRS resource indicator fields. The interpretation component 935 may be configured as or otherwise support a means for interpreting the one or more SRS resource indicator fields based on a quantity of the at least one maximum rank value (e.g., and whether at least a first uplink shared channel message and a second uplink shared channel message overlap at least partially in a time domain). The uplink component 940 may be configured as or otherwise support a means for transmitting the at least one uplink shared channel message in accordance with interpreting the one or more SRS resource indicator fields.

In some examples, to support receiving the one or more control messages, the configuration component 945 may be configured as or otherwise support a means for receiving an indication of a configuration associated with the at least one maximum rank value, where the configuration is either a first configuration or a second configuration. In some examples, the first configuration indicates that, if the at least one uplink shared channel message is associated with a single SRS resource set, a maximum rank value associated with the uplink shared channel message is equal to a larger of a first maximum rank value associated with a first SRS resource set and a second maximum rank value associated with a second SRS resource set. In some examples, the second configuration indicates that, if the at least one uplink shared channel message is associated with the single SRS resource set, the maximum rank value associated with the uplink shared channel message is equal to a summation of the first maximum rank value associated with the first SRS resource set and the second maximum rank value associated with the second SRS resource set.

In some examples, the capability component 950 may be configured as or otherwise support a means for transmitting, via a capability report, information associated with the maximum rank value the UE is capable of supporting when the at least one uplink shared channel message is associated with the single SRS resource set, or when the at least one uplink shared channel message is associated with multiple SRS resource sets, or both.

In some examples, to support receiving the one or more control messages, the control message component 925 may be configured as or otherwise support a means for receiving an indication of a respective maximum rank value for each respective SRS resource set of the set of multiple SRS resource sets configured at the UE.

In some examples, to support receiving the one or more control messages, the control message component 925 may be configured as or otherwise support a means for receiving an indication of a first maximum rank value corresponding to a quantity of layers of the first uplink shared channel message associated with a first CORESET index value, where the second uplink shared channel message associated with a second CORESET index value partially overlaps with the first uplink shared channel message. In some examples, to support receiving the one or more control messages, the control message component 925 may be configured as or otherwise support a means for receiving the indication of the first maximum rank value corresponding to the quantity of layers of the first uplink shared channel message associated with the first CORESET index value, where the second uplink shared channel message associated with the second CORESET index value is absent.

In some examples, the control message component 925 may be configured as or otherwise support a means for receiving a second indication of a second maximum rank value corresponding to the quantity of layers of the second uplink shared channel message associated with the second CORESET index value.

In some examples, the first maximum rank value and the second maximum rank value are the same or different. In some examples, the first maximum rank value and the second maximum rank value are configured in accordance with at least one of a control message format, a bandwidth part, a component carrier, or a combination thereof.

In some examples, to support transmitting the at least one uplink shared channel message, the uplink component 940 may be configured as or otherwise support a means for transmitting the at least one uplink shared channel message in accordance with one or more rules associated with a quantity of a set of multiple SRS resources, where the one or more rules state that a first maximum quantity of SRS resources is to be indicated for the first uplink shared channel message associated with a first CORESET index value, where the second uplink shared channel message associated with a second CORESET index value partially overlaps with the first uplink shared channel message in a common component carrier.

In some examples, the one or more rules state that a second maximum quantity of the SRS resources is to be indicated for the second uplink shared channel message associated with the second CORESET index value.

In some examples, the control message component 925 may be configured as or otherwise support a means for receiving a control message indicating the first maximum quantity of the SRS resources and the second maximum quantity of the SRS resources. In some examples, a summation of the first maximum quantity of the SRS resources and the second maximum quantity of the SRS resources is less than or equal to the at least one maximum rank value.

In some examples, to support receiving the one or more control messages, the control message component 925 may be configured as or otherwise support a means for receiving an indication of a first SRS resource set of the set of multiple SRS resource sets and a second SRS resource set of the set of multiple SRS resource sets, where the first SRS resource set is associated with the first uplink shared channel message and the second SRS resource set is associated with the second uplink shared channel message.

In some examples, to support transmitting the at least one uplink shared channel message, the uplink component 940 may be configured as or otherwise support a means for transmitting the at least one uplink shared channel message in accordance with one or more rules associated with the set of multiple SRS resource sets, where the one or more rules state that a first maximum quantity of SRS resources including a subset of the first SRS resource set is to be indicated for the first uplink shared channel message associated with a first CORESET index value, where the second uplink shared channel message associated with a second CORESET index value partially overlaps with the first uplink shared channel message in a common component carrier.

In some examples, the one or more rules state that a second maximum quantity of SRS resources including a subset of the second SRS resource set is to be indicated for the second uplink shared channel message associated with the second CORESET index value.

In some examples, the control message component 925 may be configured as or otherwise support a means for receiving a control message indicating the first maximum quantity of the SRS resources and the second maximum quantity of the SRS resources.

In some examples, the capability component 950 may be configured as or otherwise support a means for transmitting, via a capability report, information indicating the first maximum quantity of the SRS resources and the second maximum quantity of the SRS resources. In some examples, the first maximum quantity of the SRS resources is equal to half of the first SRS resource set and the second maximum quantity of the SRS resources is equal to half of the second SRS resource set.

In some examples, to support receiving the one or more control messages, the control message component 925 may be configured as or otherwise support a means for receiving an indication of a first SRS resource set of the set of multiple SRS resource sets for the first uplink shared channel message associated with a first CORESET index value, where the second uplink shared channel message associated with a second CORESET index value is absent. In some examples, to support receiving the one or more control messages, the control message component 925 may be configured as or otherwise support a means for receiving the indication of a second SRS resource set of the set of multiple SRS resource sets for the second uplink shared channel message associated with the second CORESET index value, where the first uplink shared channel message associated with the first CORESET index value is absent.

In some examples, to support receiving the one or more control messages, the control message component 925 may be configured as or otherwise support a means for receiving the indication of a third SRS resource set of the set of multiple SRS resource sets for the first uplink shared channel message associated with the first CORESET index value, where the second uplink shared channel message associated with the second CORESET index value partially overlaps with the first uplink shared channel message. In some examples, to support receiving the one or more control messages, the control message component 925 may be configured as or otherwise support a means for receiving the indication of a fourth SRS resource set of the set of multiple SRS resource sets for the second uplink shared channel message associated with the second CORESET index value, where the first uplink shared channel message associated with the first CORESET index value partially overlaps with the second uplink shared channel message.

In some examples, the first SRS resource set and the third SRS resource set are associated with a common channel state information resource set and a common set of power control parameters. In some examples, the second SRS resource set and the fourth SRS resource set are associated with a common channel state information resource set and a common set of power control parameters.

In some examples, a quantity of resources in the third SRS resource set is less than a quantity of resources in the first SRS resource set. In some examples, a quantity of resources in the fourth SRS resource set is less than a quantity of resources in the second SRS resource set.

In some examples, to support receiving the one or more control messages, the control message component 925 may be configured as or otherwise support a means for receiving an indication of a first maximum rank value corresponding to the first uplink shared channel message associated with a first CORESET index value, where the second uplink shared channel message associated with a second CORESET index value is absent. In some examples, to support receiving the one or more control messages, the control message component 925 may be configured as or otherwise support a means for receiving the indication of a second maximum rank value corresponding to the first uplink shared channel message associated with the first CORESET index value and a third maximum rank value corresponding to the second uplink shared channel message associated with the second CORESET index value, where the second uplink shared channel message associated with the second CORESET index value partially overlaps with the first uplink shared channel message.

In some examples, the second maximum rank value and the third maximum rank value are the same or different. In some examples, the second maximum rank value and the third maximum rank value are configured in accordance with at least one of a control message format, a bandwidth part, a component carrier, or a combination thereof. In some examples, a summation of the second maximum rank value and the third maximum rank value is less than or equal to the first maximum rank value.

In some examples, the control message component 925 may be configured as or otherwise support a means for receiving a control message including an indication of SRS resource set selection, where interpreting the one or more SRS resource indicator fields is based on the indication of SRS resource set selection and the first CORESET index value or the second CORESET index value. In some examples, the one or more control messages include an indication of a presence of multiple uplink shared channel messages that overlap at least partially in a time domain.

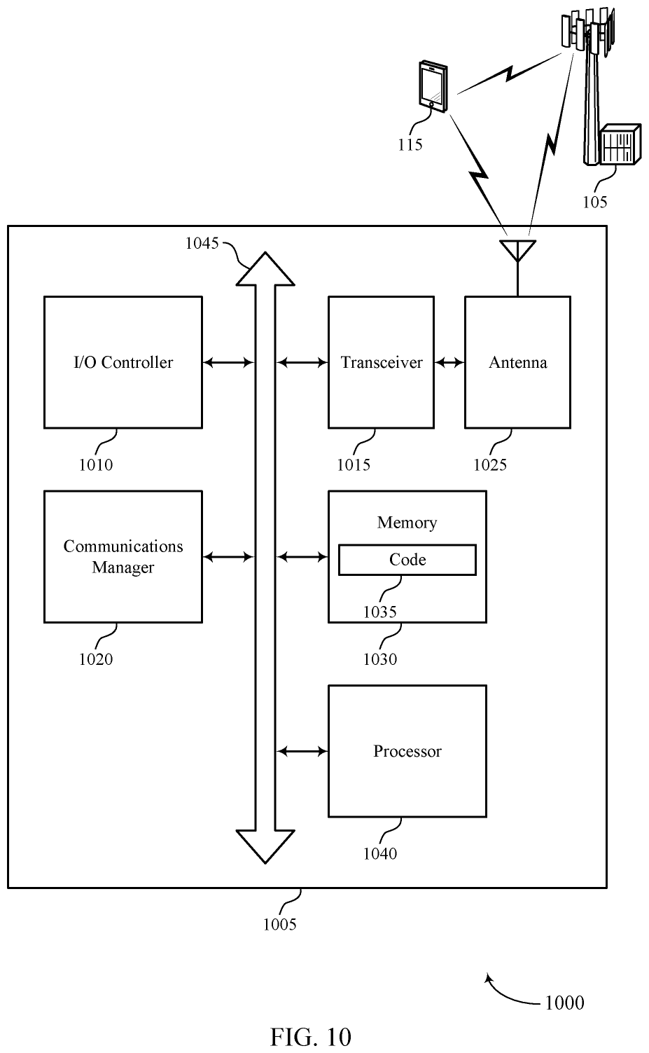

FIG. 10 shows a diagram of a system 1000 including a device 1005 that supports SRS indicator designs for non-CB-based communications in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting SRS indicator designs for non-CB-based communications). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. The one or more control messages may indicate at least one maximum rank value that being associated with uplink shared channel transmissions from the UE, the at least one maximum rank value being based on a threshold quantity of rank values supported by the UE.

The communications manager 1020 may be configured as or otherwise support a means for receiving a message including DCI that schedules at least one uplink shared channel message, the DCI message including the one or more SRS resource indicator fields. The communications manager 1020 may be configured as or otherwise support a means for interpreting the one or more SRS resource indicator fields based on a quantity of the at least one maximum rank value (e.g., and whether at least a first uplink shared channel message and a second uplink shared channel message overlap at least partially in a time domain). The communications manager 1020 may be configured as or otherwise support a means for transmitting the at least one uplink shared channel message in accordance with interpreting the one or more SRS resource indicator fields.

By including or configuring the communications manager 1020 in accordance with examples as described herein, the device 1005 may support techniques for improved communication reliability, reduced latency, improved user experience related to reduced processing, reduced power consumption, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of SRS indicator designs for non-CB-based communications as described herein, or the processor 1040 and the memory 1030 may be otherwise configured to perform or support such operations.

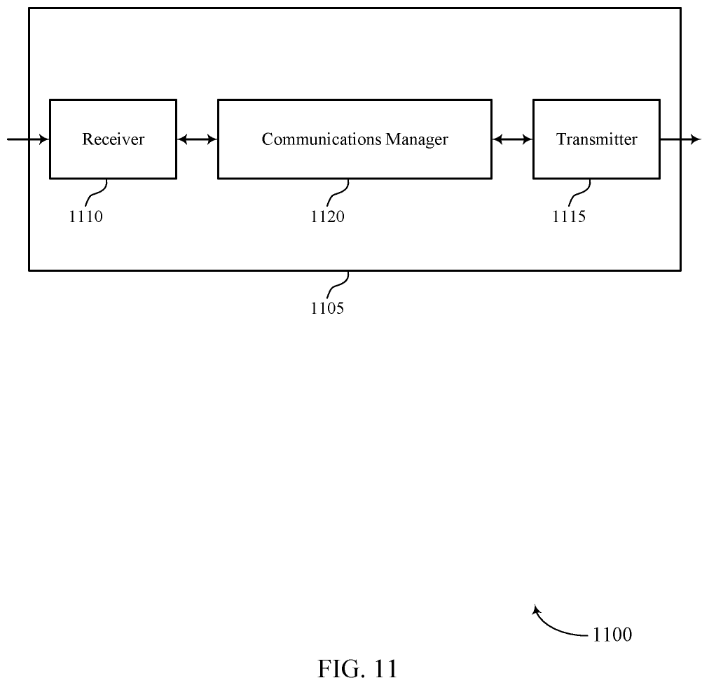

FIG. 11 shows a block diagram 1100 of a device 1105 that supports SRS indicator designs for non-CB-based communications in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of SRS indicator designs for non-CB-based communications as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. The one or more control messages may indicate at least one maximum rank value that being associated with uplink shared channel transmissions from a UE, the at least one maximum rank value being based on a threshold quantity of rank values supported by the UE.

The communications manager 1120 may be configured as or otherwise support a means for transmitting a message including DCI that schedules at least one uplink shared channel message, the DCI message including one or more SRS resource indicator fields. The communications manager 1120 may be configured as or otherwise support a means for receiving the at least one uplink shared channel message in accordance with interpreting the one or more SRS resource indicator fields, where the one or more SRS resource indicator fields is interpreted based on a quantity of the at least one maximum rank value (e.g., and whether at least a first uplink shared channel message and a second uplink shared channel message overlap at least partially in a time domain).

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing, reduced power consumption, and more efficient utilization of communication resources.

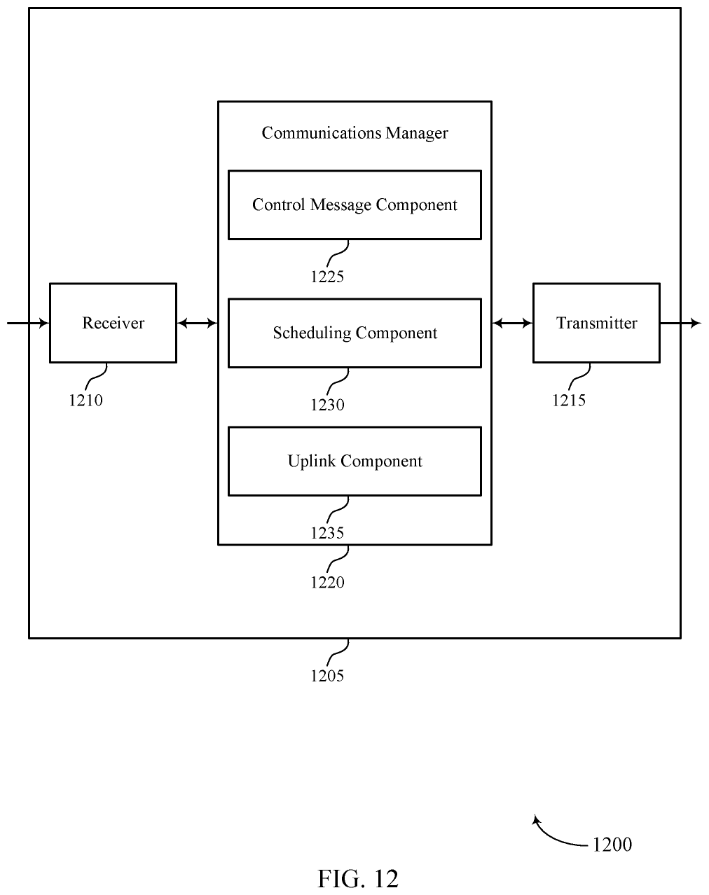

FIG. 12 shows a block diagram 1200 of a device 1205 that supports SRS indicator designs for non-CB-based communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of SRS indicator designs for non-CB-based communications as described herein. For example, the communications manager 1220 may include a control message component 1225, a scheduling component 1230, an uplink component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The control message component 1225 may be configured as or otherwise support a means for transmitting one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. The one or more control messages may indicate at least one maximum rank value that is associated with uplink shared channel transmissions from a UE, the at least one maximum rank value being based on a threshold quantity of rank values supported by the UE.

The scheduling component 1230 may be configured as or otherwise support a means for transmitting a message including DCI that schedules at least one uplink shared channel message, the DCI message including one or more SRS resource indicator fields. The uplink component 1235 may be configured as or otherwise support a means for receiving the at least one uplink shared channel message in accordance with interpreting the one or more SRS resource indicator fields, where the one or more SRS resource indicator fields is interpreted based on a quantity of the at least one maximum rank value (e.g., and whether at least a first uplink shared channel message and a second uplink shared channel message overlap at least partially in a time domain).

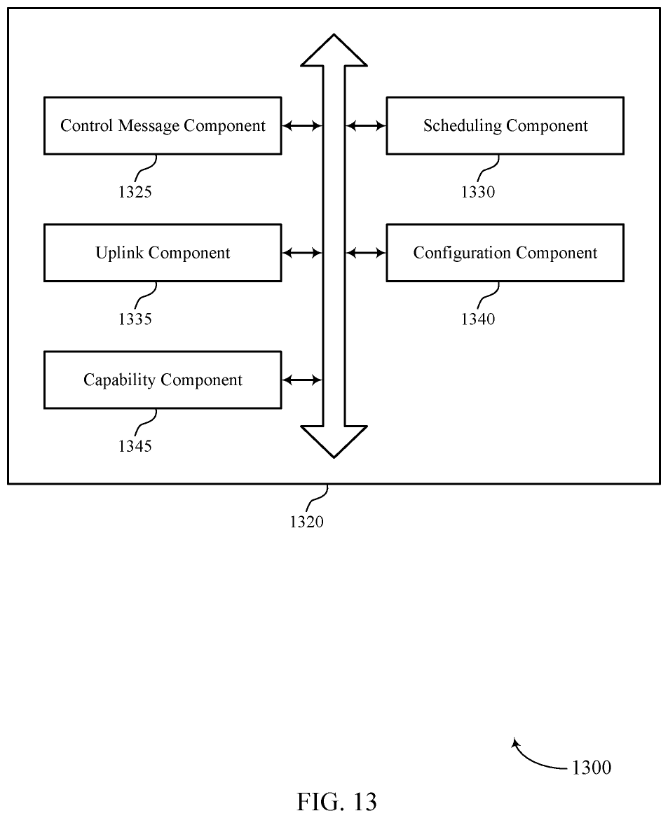

FIG. 13 shows a block diagram 1300 of a communications manager 1320 that supports SRS indicator designs for non-CB-based communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of SRS indicator designs for non-CB-based communications as described herein. For example, the communications manager 1320 may include a control message component 1325, a scheduling component 1330, an uplink component 1335, a configuration component 1340, a capability component 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The control message component 1325 may be configured as or otherwise support a means for transmitting one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. The one or more control messages may indicate at least one maximum rank value that is associated with uplink shared channel transmissions from a UE, the at least one maximum rank value being based on a threshold quantity of rank values supported by the UE.

The scheduling component 1330 may be configured as or otherwise support a means for transmitting a message including DCI that schedules at least one uplink shared channel message, the DCI message including one or more SRS resource indicator fields. The uplink component 1335 may be configured as or otherwise support a means for receiving the at least one uplink shared channel message in accordance with interpreting the one or more SRS resource indicator fields, where the one or more SRS resource indicator fields is interpreted based on a quantity of the at least one maximum rank value (e.g., and whether at least a first uplink shared channel message and a second uplink shared channel message overlap at least partially in a time domain).

In some examples, to support transmitting the one or more control messages, the configuration component 1340 may be configured as or otherwise support a means for transmitting an indication of a configuration associated with the at least one maximum rank value, where the configuration is either a first configuration or a second configuration. In some examples, the first configuration indicates that, if the at least one uplink shared channel message is associated with a single SRS resource set, a maximum rank value associated with the uplink shared channel message is equal to a larger of a first maximum rank value associated with a first SRS resource set and a second maximum rank value associated with a second SRS resource set. In some examples, the second configuration indicates that, if the at least one uplink shared channel message is associated with the single SRS resource set, the maximum rank value associated with the uplink shared channel message is equal to a summation of the first maximum rank value associated with the first SRS resource set and the second maximum rank value associated with the second SRS resource set.

In some examples, the capability component 1345 may be configured as or otherwise support a means for receiving, via a capability report, information associated with the maximum rank value the UE is capable of supporting when the at least one uplink shared channel message is associated with the single SRS resource set, or when the at least one uplink shared channel message is associated with multiple SRS resource sets, or both.

In some examples, to support transmitting the one or more control messages, the control message component 1325 may be configured as or otherwise support a means for transmitting an indication of a respective maximum rank value for each respective SRS resource set of the set of multiple SRS resource sets configured at the UE.

In some examples, to support transmitting the one or more control messages, the control message component 1325 may be configured as or otherwise support a means for transmitting an indication of a first maximum rank value corresponding to a quantity of layers of the first uplink shared channel message associated with a first CORESET index value, where the second uplink shared channel message associated with a second CORESET index value partially overlaps with the first uplink shared channel message. In some examples, to support transmitting the one or more control messages, the control message component 1325 may be configured as or otherwise support a means for transmitting the indication of the first maximum rank value corresponding to the quantity of layers of the first uplink shared channel message associated with the first CORESET index value, where the second uplink shared channel message associated with the second CORESET index value is absent.

In some examples, the control message component 1325 may be configured as or otherwise support a means for transmitting a second indication of a second maximum rank value corresponding to the quantity of layers of the second uplink shared channel message associated with the second CORESET index value.

In some examples, the first maximum rank value and the second maximum rank value are the same or different. In some examples, the first maximum rank value and the second maximum rank value are configured in accordance with at least one of a control message format, a bandwidth part, a component carrier, or a combination thereof.

In some examples, to support receiving the at least one uplink shared channel message, the uplink component 1335 may be configured as or otherwise support a means for receiving the at least one uplink shared channel message in accordance with one or more rules associated with a quantity of a set of multiple SRS resources, where the one or more rules state that a first maximum quantity of SRS resources is to be indicated for the first uplink shared channel message associated with a first CORESET index value, where the second uplink shared channel message associated with a second CORESET index value partially overlaps with the first uplink shared channel message in a common component carrier.

In some examples, the one or more rules state that a second maximum quantity of the SRS resources is to be indicated for the second uplink shared channel message associated with the second CORESET index value. In some examples, the control message component 1325 may be configured as or otherwise support a means for transmitting a control message indicating the first maximum quantity of the SRS resources and the second maximum quantity of the SRS resources. In some examples, a summation of the first maximum quantity of the SRS resources and the second maximum quantity of the SRS resources is less than or equal to the at least one maximum rank value.

In some examples, to support transmitting the one or more control messages, the control message component 1325 may be configured as or otherwise support a means for transmitting an indication of a first SRS resource set of the set of multiple SRS resource sets and a second SRS resource set of the set of multiple SRS resource sets, where the first SRS resource set is associated with the first uplink shared channel message and the second SRS resource set is associated with the second uplink shared channel message.

In some examples, to support receiving the at least one uplink shared channel message, the uplink component 1335 may be configured as or otherwise support a means for receiving the at least one uplink shared channel message in accordance with one or more rules associated with the set of multiple SRS resource sets, where the one or more rules state that a first maximum quantity of SRS resources including a subset of the first SRS resource set is to be indicated for the first uplink shared channel message associated with a first CORESET index value, where the second uplink shared channel message associated with a second CORESET index value partially overlaps with the first uplink shared channel message in a common component carrier.

In some examples, the one or more rules state that a second maximum quantity of SRS resources including a subset of the second SRS resource set is to be indicated for the second uplink shared channel message associated with the second CORESET index value. In some examples, the control message component 1325 may be configured as or otherwise support a means for transmitting a control message indicating the first maximum quantity of the SRS resources and the second maximum quantity of the SRS resources.

In some examples, the capability component 1345 may be configured as or otherwise support a means for receiving, via a capability report, information indicating the first maximum quantity of the SRS resources and the second maximum quantity of the SRS resources. In some examples, the first maximum quantity of the SRS resources is equal to half of the first SRS resource set and the second maximum quantity of the SRS resources is equal to half of the second SRS resource set.

In some examples, to support transmitting the one or more control messages, the control message component 1325 may be configured as or otherwise support a means for transmitting an indication of a first SRS resource set of the set of multiple SRS resource sets for the first uplink shared channel message associated with a first CORESET index value, where the second uplink shared channel message associated with a second CORESET index value is absent. In some examples, to support transmitting the one or more control messages, the control message component 1325 may be configured as or otherwise support a means for transmitting the indication of a second SRS resource set of the set of multiple SRS resource sets for the second uplink shared channel message associated with the second CORESET index value, where the first uplink shared channel message associated with the first CORESET index value is absent.

In some examples, to support transmitting the one or more control messages, the control message component 1325 may be configured as or otherwise support a means for transmitting the indication of a third SRS resource set of the set of multiple SRS resource sets for the first uplink shared channel message associated with the first CORESET index value, where the second uplink shared channel message associated with the second CORESET index value partially overlaps with the first uplink shared channel message. In some examples, to support transmitting the one or more control messages, the control message component 1325 may be configured as or otherwise support a means for transmitting the indication of a fourth SRS resource set of the set of multiple SRS resource sets for the second uplink shared channel message associated with the second CORESET index value, where the first uplink shared channel message associated with the first CORESET index value partially overlaps with the second uplink shared channel message.

In some examples, the first SRS resource set and the third SRS resource set are associated with a common channel state information resource set and a common set of power control parameters. In some examples, the second SRS resource set and the fourth SRS resource set are associated with a common channel state information resource set and a common set of power control parameters.

In some examples, a quantity of resources in the third SRS resource set is less than a quantity of resources in the first SRS resource set. In some examples, a quantity of resources in the fourth SRS resource set is less than a quantity of resources in the second SRS resource set.

In some examples, to support transmitting the one or more control messages, the control message component 1325 may be configured as or otherwise support a means for transmitting an indication of a first maximum rank value corresponding to the first uplink shared channel message associated with a first CORESET index value, where the second uplink shared channel message associated with a second CORESET index value is absent. In some examples, to support transmitting the one or more control messages, the control message component 1325 may be configured as or otherwise support a means for transmitting the indication of a second maximum rank value corresponding to the first uplink shared channel message associated with the first CORESET index value and a third maximum rank value corresponding to the second uplink shared channel message associated with the second CORESET index value, where the second uplink shared channel message associated with the second CORESET index value partially overlaps with the first uplink shared channel message. In some examples, the second maximum rank value and the third maximum rank value are the same or different.

In some examples, the second maximum rank value and the third maximum rank value are configured in accordance with at least one of a control message format, a bandwidth part, a component carrier, or a combination thereof. In some examples, a summation of the second maximum rank value and the third maximum rank value is less than or equal to the first maximum rank value.

In some examples, the control message component 1325 may be configured as or otherwise support a means for transmitting a control message including an indication of SRS resource set selection, where interpreting the one or more SRS resource indicator fields is based on the indication of SRS resource set selection and the first CORESET index value or the second CORESET index value. In some examples, the one or more control messages include an indication of a presence of multiple uplink shared channel messages that overlap at least partially in a time domain.

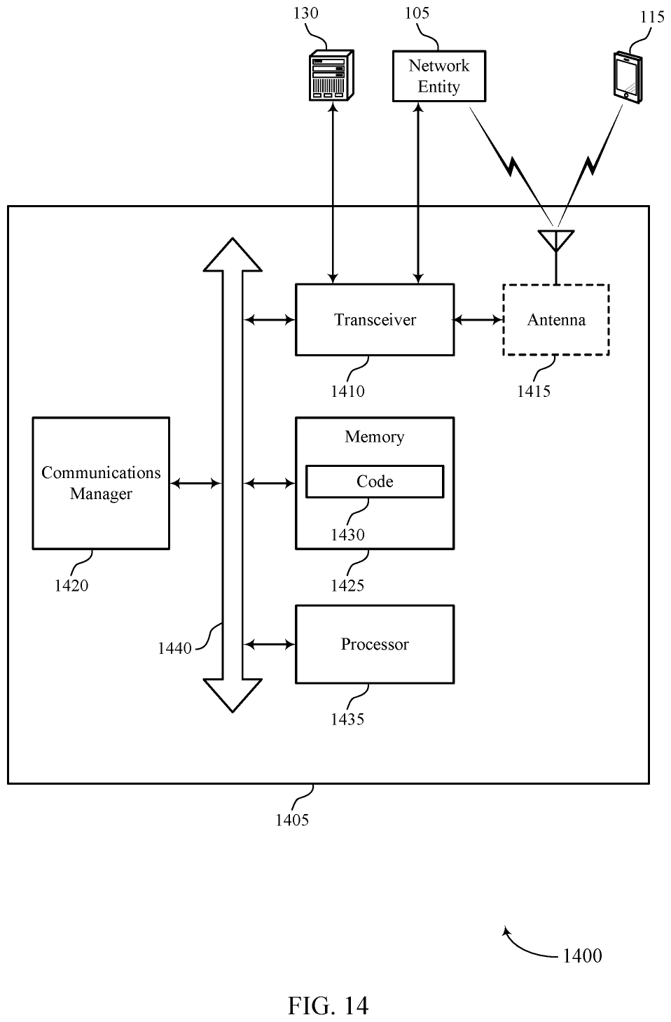

FIG. 14 shows a diagram of a system 1400 including a device 1405 that supports SRS indicator designs for non-CB-based communications in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting SRS indicator designs for non-CB-based communications). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting one or more control messages that indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. The one or more control messages may indicate at least one maximum rank value that being associated with uplink shared channel transmissions from a UE, the at least one maximum rank value being based on a threshold quantity of rank values supported by the UE.

The communications manager 1420 may be configured as or otherwise support a means for transmitting a message including DCI that schedules at least one uplink shared channel message, the DCI message including one or more SRS resource indicator fields. The communications manager 1420 may be configured as or otherwise support a means for receiving the at least one uplink shared channel message in accordance with interpreting the one or more SRS resource indicator fields, where the one or more SRS resource indicator fields is interpreted based on a quantity of the at least one maximum rank value (e.g., and whether at least a first uplink shared channel message and a second uplink shared channel message overlap at least partially in a time domain).

By including or configuring the communications manager 1420 in accordance with examples as described herein, the device 1405 may support techniques for improved communication reliability, reduced latency, improved user experience related to reduced processing, reduced power consumption, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of SRS indicator designs for non-CB-based communications as described herein, or the processor 1435 and the memory 1425 may be otherwise configured to perform or support such operations.

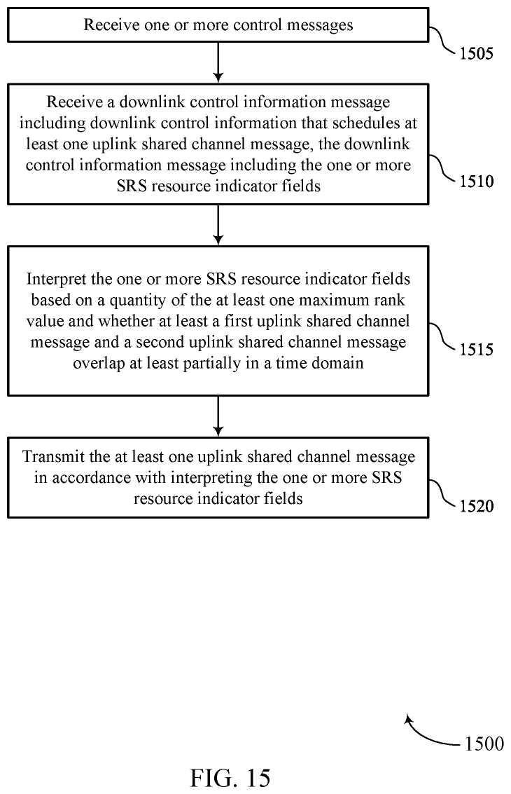

FIG. 15 shows a flowchart illustrating a method 1500 that supports SRS indicator designs for non-CB-based communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving one or more control messages. In some examples, the one or more control messages indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. In some examples, the one or more control messages indicate at least one maximum rank value that is associated with uplink shared channel transmissions from the UE, the at least one maximum rank value being based on a threshold quantity of rank values supported by the UE. The operations of 1505 may be performed in accordance with examples as disclosed herein. In some examples, aspects of the operations of 1505 may be performed by a control message component 925 as described with reference to FIG. 9.

At 1510, the method may include receiving a DCI message including DCI that schedules at least one uplink shared channel message, the DCI message including the one or more SRS resource indicator fields. The operations of 1510 may be performed in accordance with examples as disclosed herein. In some examples, aspects of the operations of 1510 may be performed by a scheduling component 930 as described with reference to FIG. 9.

At 1515, the method may include interpreting the one or more SRS resource indicator fields based on a quantity of the at least one maximum rank value (e.g., and whether at least a first uplink shared channel message and a second uplink shared channel message overlap at least partially in a time domain). The operations of 1515 may be performed in accordance with examples as disclosed herein. In some examples, aspects of the operations of 1515 may be performed by an interpretation component 935 as described with reference to FIG. 9.

At 1520, the method may include transmitting the at least one uplink shared channel message in accordance with interpreting the one or more SRS resource indicator fields. The operations of 1520 may be performed in accordance with examples as disclosed herein. In some examples, aspects of the operations of 1520 may be performed by an uplink component 940 as described with reference to FIG. 9.

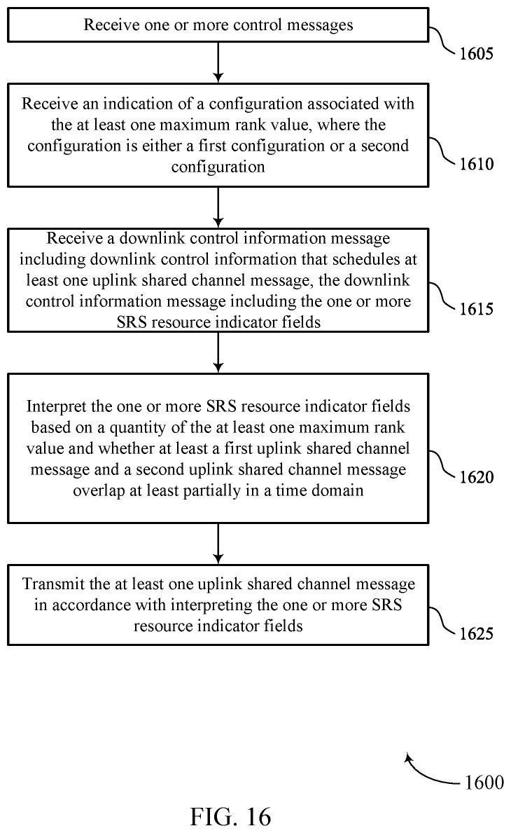

FIG. 16 shows a flowchart illustrating a method 1600 that supports SRS indicator designs for non-CB-based communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving one or more control messages. The one or more control messages may indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. In some examples, the one or more control messages may indicate at least one maximum rank value that is associated with uplink shared channel transmissions from the UE, the at least one maximum rank value being based on a threshold quantity of rank values supported by the UE. The operations of 1605 may be performed in accordance with examples as disclosed herein. In some examples, aspects of the operations of 1605 may be performed by a control message component 925 as described with reference to FIG. 9.

At 1610, the method may include receiving an indication of a configuration associated with the at least one maximum rank value, where the configuration is either a first configuration or a second configuration. In some examples, the first configuration indicates that, if the at least one uplink shared channel message is associated with a single SRS resource set, a maximum rank value associated with the uplink shared channel message is equal to a larger of a first maximum rank value associated with a first SRS resource set and a second maximum rank value associated with a second SRS resource set. In some examples, the second configuration indicates that, if the at least one uplink shared channel message is associated with the single SRS resource set, the maximum rank value associated with the uplink shared channel message is equal to a summation of the first maximum rank value associated with the first SRS resource set and the second maximum rank value associated with the second SRS resource set. The operations of 1610 may be performed in accordance with examples as disclosed herein. In some examples, aspects of the operations of 1610 may be performed by a configuration component 945 as described with reference to FIG. 9.

At 1615, the method may include receiving a DCI message including DCI that schedules at least one uplink shared channel message, the DCI message including the one or more SRS resource indicator fields. The operations of 1615 may be performed in accordance with examples as disclosed herein. In some examples, aspects of the operations of 1615 may be performed by a scheduling component 930 as described with reference to FIG. 9.

At 1620, the method may include interpreting the one or more SRS resource indicator fields based on a quantity of the at least one maximum rank value (e.g., and whether at least a first uplink shared channel message and a second uplink shared channel message overlap at least partially in a time domain). The operations of 1620 may be performed in accordance with examples as disclosed herein. In some examples, aspects of the operations of 1620 may be performed by an interpretation component 935 as described with reference to FIG. 9.

At 1625, the method may include transmitting the at least one uplink shared channel message in accordance with interpreting the one or more SRS resource indicator fields. The operations of 1625 may be performed in accordance with examples as disclosed herein. In some examples, aspects of the operations of 1625 may be performed by an uplink component 940 as described with reference to FIG. 9.

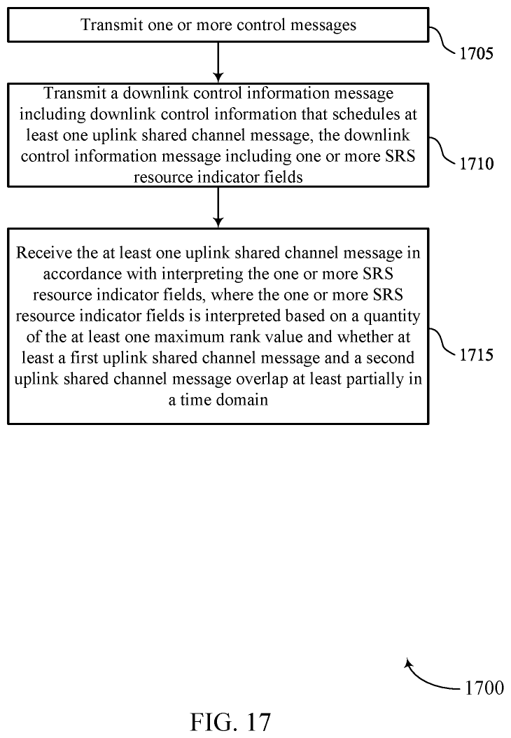

FIG. 17 shows a flowchart illustrating a method 1700 that supports SRS indicator designs for non-CB-based communications in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting one or more control messages. In some examples, the one or more control messages may indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. In some examples, the one or more control messages may indicate at least one maximum rank value that is associated with uplink shared channel transmissions from a UE, the at least one maximum rank value being based on a threshold quantity of rank values supported by the UE. The operations of 1705 may be performed in accordance with examples as disclosed herein. In some examples, aspects of the operations of 1705 may be performed by a control message component 1325 as described with reference to FIG. 13.

At 1710, the method may include transmitting a DCI message including DCI that schedules at least one uplink shared channel message, the DCI message including one or more SRS resource indicator fields. The operations of 1710 may be performed in accordance with examples as disclosed herein. In some examples, aspects of the operations of 1710 may be performed by a scheduling component 1330 as described with reference to FIG. 13.

At 1715, the method may include receiving the at least one uplink shared channel message in accordance with interpreting the one or more SRS resource indicator fields, where the one or more SRS resource indicator fields is interpreted based on a quantity of the at least one maximum rank value (e.g., and whether at least a first uplink shared channel message and a second uplink shared channel message overlap at least partially in a time domain). The operations of 1715 may be performed in accordance with examples as disclosed herein. In some examples, aspects of the operations of 1715 may be performed by an uplink component 1335 as described with reference to FIG. 13.

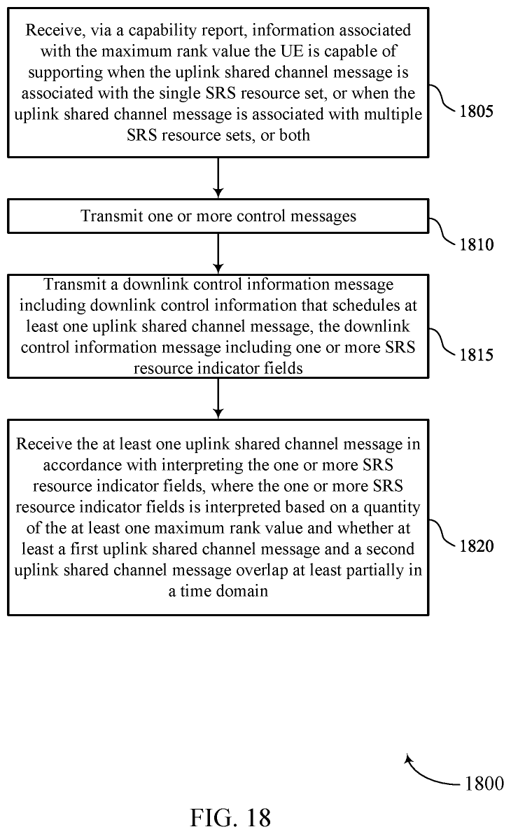

FIG. 18 shows a flowchart illustrating a method 1800 that supports SRS indicator designs for non-CB-based communications in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving, via a capability report, information associated with the maximum rank value the UE is capable of supporting when the at least one uplink shared channel message is associated with the single SRS resource set, or when the at least one uplink shared channel message is associated with multiple SRS resource sets, or both. The operations of 1805 may be performed in accordance with examples as disclosed herein. In some examples, aspects of the operations of 1805 may be performed by a capability component 1345 as described with reference to FIG. 13.

At 1810, the method may include transmitting one or more control messages. In some examples, the one or more control messages may indicate a quantity of a set of multiple SRS resource sets, a quantity of one or more SRS resource indicator fields included in one or more control messages, and a set of parameters for multiple uplink shared channel messages, where the set of multiple SRS resource sets are configured for non-CB usage. In some examples, the one or more control messages may indicate at least one maximum rank value that is associated with uplink shared channel transmissions from a UE, the at least one maximum rank value being based on a threshold quantity of rank values supported by the UE. The operations of 1810 may be performed in accordance with examples as disclosed herein. In some examples, aspects of the operations of 1810 may be performed by a control message component 1325 as described with reference to FIG. 13.

At 1815, the method may include transmitting a DCI message including DCI that schedules at least one uplink shared channel message, the DCI message including one or more SRS resource indicator fields. The operations of 1825 may be performed in accordance with examples as disclosed herein. In some examples, aspects of the operations of 1825 may be performed by a scheduling component 1330 as described with reference to FIG. 13.

At 1820, the method may include receiving the at least one uplink shared channel message in accordance with interpreting the one or more SRS resource indicator fields, where the one or more SRS resource indicator fields is interpreted based on a quantity of the at least one maximum rank value (e.g., and whether at least a first uplink shared channel message and a second uplink shared channel message overlap at least partially in a time domain). The operations of 1830 may be performed in accordance with examples as disclosed herein. In some examples, aspects of the operations of 1830 may be performed by an uplink component 1335 as described with reference to FIG. 13.

The following provides an overview of aspects of the present disclosure:

Aspect 1: A method for wireless communication by a UE, comprising: receiving one or more control messages that indicate: a quantity of a plurality of SRS resource sets, a quantity of one or more SRS resource indicator fields included in one or more control messages, and a set of parameters for multiple uplink shared channel messages, wherein the plurality of SRS resource sets are configured for non-CB usage, and at least one maximum rank value that is associated with uplink shared channel transmissions from the UE, the at least one maximum rank value being based at least in part on a threshold quantity of rank values supported by the UE; receiving a DCI message comprising DCI that schedules at least one uplink shared channel message, the DCI message including the one or more SRS resource indicator fields; interpreting the one or more SRS resource indicator fields based at least in part on a quantity of the at least one maximum rank value; and transmitting the at least one uplink shared channel message in accordance with interpreting the one or more SRS resource indicator fields.

Aspect 2: The method of aspect 1, wherein receiving the one or more control messages further comprises: receiving an indication of a configuration associated with the at least one maximum rank value, wherein the configuration is either a first configuration or a second configuration, wherein: the first configuration indicates that, if the at least one uplink shared channel message is associated with a single SRS resource set, a maximum rank value associated with the at least one uplink shared channel message is equal to a larger of a first maximum rank value associated with a first SRS resource set and a second maximum rank value associated with a second SRS resource set, and the second configuration indicates that, if the at least one uplink shared channel message is associated with the single SRS resource set, the maximum rank value associated with the at least one uplink shared channel message is equal to a summation of the first maximum rank value associated with the first SRS resource set and the second maximum rank value associated with the second SRS resource set.

Aspect 3: The method of aspect 2, further comprising: transmitting, via a capability report, information associated with the maximum rank value the UE is capable of supporting when the at least one uplink shared channel message is associated with the single SRS resource set, or when the at least one uplink shared channel message is associated with multiple SRS resource sets, or both.

Aspect 4: The method of any of aspects 1 through 3, wherein receiving the one or more control messages further comprises: receiving an indication of a respective maximum rank value for each respective SRS resource set of the plurality of SRS resource sets configured at the UE.

Aspect 5: The method of any of aspects 1 through 4, wherein receiving the one or more control messages further comprises: receiving an indication of a first maximum rank value corresponding to a quantity of layers of the first uplink shared channel message associated with a first control resource set index value, wherein the second uplink shared channel message associated with a second control resource set index value partially overlaps with the first uplink shared channel message; or receiving the indication of the first maximum rank value corresponding to the quantity of layers of the first uplink shared channel message associated with the first control resource set index value, wherein the second uplink shared channel message associated with the second control resource set index value is absent.

Aspect 6: The method of aspect 5, further comprising: receiving a second indication of a second maximum rank value corresponding to the quantity of layers of the second uplink shared channel message associated with the second control resource set index value.

Aspect 7: The method of aspect 6, wherein the first maximum rank value and the second maximum rank value are the same or different.

Aspect 8: The method of any of aspects 6 through 7, wherein the first maximum rank value and the second maximum rank value are configured in accordance with at least one of a control message format, a bandwidth part, a component carrier, or a combination thereof.

Aspect 9: The method of any of aspects 1 through 8, wherein transmitting the at least one uplink shared channel message further comprises: transmitting the at least one uplink shared channel message in accordance with one or more rules associated with a quantity of a plurality of SRS resources, wherein the one or more rules state that a first maximum quantity of SRS resources is to be indicated for the first uplink shared channel message associated with a first control resource set index value, wherein the second uplink shared channel message associated with a second control resource set index value partially overlaps with the first uplink shared channel message in a common component carrier.

Aspect 10: The method of aspect 9, wherein the one or more rules state that a second maximum quantity of the SRS resources is to be indicated for the second uplink shared channel message associated with the second control resource set index value.

Aspect 11: The method of aspect 10, further comprising: receiving a control message indicating the first maximum quantity of the SRS resources and the second maximum quantity of the SRS resources.

Aspect 12: The method of any of aspects 10 through 11, wherein a summation of the first maximum quantity of the SRS resources and the second maximum quantity of the SRS resources is less than or equal to the at least one maximum rank value.

Aspect 13: The method of any of aspects 1 through 12, wherein receiving the one or more control messages further comprises: receiving an indication of a first SRS resource set of the plurality of SRS resource sets and a second SRS resource set of the plurality of SRS resource sets, wherein the first SRS resource set is associated with the first uplink shared channel message and the second SRS resource set is associated with the second uplink shared channel message.

Aspect 14: The method of aspect 13, wherein transmitting the at least one uplink shared channel message further comprises: transmitting the at least one uplink shared channel message in accordance with one or more rules associated with the plurality of SRS resource sets, wherein the one or more rules state that a first maximum quantity of SRS resources comprising a subset of the first SRS resource set is to be indicated for the first uplink shared channel message associated with a first control resource set index value, wherein the second uplink shared channel message associated with a second control resource set index value partially overlaps with the first uplink shared channel message in a common component carrier.

Aspect 15: The method of aspect 14, wherein the one or more rules state that a second maximum quantity of SRS resources comprising a subset of the second SRS resource set is to be indicated for the second uplink shared channel message associated with the second control resource set index value.

Aspect 16: The method of aspect 15, further comprising: receiving a control message indicating the first maximum quantity of the SRS resources and the second maximum quantity of the SRS resources.

Aspect 17: The method of any of aspects 15 through 16, further comprising: transmitting, via a capability report, information indicating the first maximum quantity of the SRS resources and the second maximum quantity of the SRS resources.

Aspect 18: The method of any of aspects 15 through 17, wherein the first maximum quantity of the SRS resources is equal to half of the first SRS resource set and the second maximum quantity of the SRS resources is equal to half of the second SRS resource set.

Aspect 19: The method of any of aspects 1 through 18, wherein receiving the one or more control messages further comprises: receiving an indication of a first SRS resource set of the plurality of SRS resource sets for the first uplink shared channel message associated with a first control resource set index value, wherein the second uplink shared channel message associated with a second control resource set index value is absent; or receiving the indication of a second SRS resource set of the plurality of SRS resource sets for the second uplink shared channel message associated with the second control resource set index value, wherein the first uplink shared channel message associated with the first control resource set index value is absent; or receiving the indication of a third SRS resource set of the plurality of SRS resource sets for the first uplink shared channel message associated with the first control resource set index value, wherein the second uplink shared channel message associated with the second control resource set index value partially overlaps with the first uplink shared channel message; or receiving the indication of a fourth SRS resource set of the plurality of SRS resource sets for the second uplink shared channel message associated with the second control resource set index value, wherein the first uplink shared channel message associated with the first control resource set index value partially overlaps with the second uplink shared channel message.

Aspect 20: The method of aspect 19, wherein the first SRS resource set and the third SRS resource set are associated with a common channel state information resource set and a common set of power control parameters.

Aspect 21: The method of any of aspects 19 through 20, wherein the second SRS resource set and the fourth SRS resource set are associated with a common channel state information resource set and a common set of power control parameters.

Aspect 22: The method of any of aspects 19 through 21, wherein a quantity of resources in the third SRS resource set is less than a quantity of resources in the first SRS resource set.

Aspect 23: The method of any of aspects 19 through 22, wherein a quantity of resources in the fourth SRS resource set is less than a quantity of resources in the second SRS resource set.

Aspect 24: The method of any of aspects 1 through 23, wherein receiving the one or more control messages further comprises: receiving an indication of a first maximum rank value corresponding to the first uplink shared channel message associated with a first control resource set index value, wherein the second uplink shared channel message associated with a second control resource set index value is absent; or receiving the indication of a second maximum rank value corresponding to the first uplink shared channel message associated with the first control resource set index value and a third maximum rank value corresponding to the second uplink shared channel message associated with the second control resource set index value, wherein the second uplink shared channel message associated with the second control resource set index value partially overlaps with the first uplink shared channel message.

Aspect 25: The method of aspect 24, wherein the second maximum rank value and the third maximum rank value are the same or different.

Aspect 26: The method of any of aspects 24 through 25, wherein the second maximum rank value and the third maximum rank value are configured in accordance with at least one of a control message format, a bandwidth part, a component carrier, or a combination thereof.

Aspect 27: The method of any of aspects 24 through 26, wherein a summation of the second maximum rank value and the third maximum rank value is less than or equal to the first maximum rank value.

Aspect 28: The method of any of aspects 24 through 27, further comprising: receiving a control message comprising an indication of SRS resource set selection, wherein interpreting the one or more SRS resource indicator fields is based at least in part on the indication of SRS resource set selection and the first control resource set index value or the second control resource set index value.

Aspect 29: The method of any of aspects 1 through 28, wherein the one or more control messages comprise an indication of a presence of multiple uplink shared channel messages that overlap at least partially in a time domain.

Aspect 30: A method for wireless communication by a network entity, comprising: transmitting one or more control messages that indicate: a quantity of a plurality of SRS resource sets, a quantity of one or more SRS resource indicator fields included in one or more control messages, and a set of parameters for multiple uplink shared channel messages, wherein the plurality of SRS resource sets are configured for non-CB usage, and at least one maximum rank value that is associated with uplink shared channel transmissions from a UE, the at least one maximum rank value being based at least in part on a threshold quantity of rank values supported by the UE; transmitting a DCI message comprising DCI that schedules at least one uplink shared channel message, the DCI message including one or more SRS resource indicator fields; and receiving the at least one uplink shared channel message in accordance with interpreting the one or more SRS resource indicator fields, wherein the one or more SRS resource indicator fields is interpreted based at least in part on a quantity of the at least one maximum rank value.

Aspect 31: The method of aspect 30, wherein transmitting the one or more control messages further comprises: transmitting an indication of a configuration associated with the at least one maximum rank value, wherein the configuration is either a first configuration or a second configuration, wherein: the first configuration indicates that, if the at least one uplink shared channel message is associated with a single SRS resource set, a maximum rank value associated with the at least one uplink shared channel message is equal to a larger of a first maximum rank value associated with a first SRS resource set and a second maximum rank value associated with a second SRS resource set, and the second configuration indicates that, if the at least one uplink shared channel message is associated with the single SRS resource set, the maximum rank value associated with the at least one uplink shared channel message is equal to a summation of the first maximum rank value associated with the first SRS resource set and the second maximum rank value associated with the second SRS resource set.

Aspect 32: The method of aspect 31, further comprising: receiving, via a capability report, information associated with the maximum rank value the UE is capable of supporting when the at least one uplink shared channel message is associated with the single SRS resource set, or when the at least one uplink shared channel message is associated with multiple SRS resource sets, or both.

Aspect 33: The method of any of aspects 30 through 32, wherein transmitting the one or more control messages further comprises: transmitting an indication of a respective maximum rank value for each respective SRS resource set of the plurality of SRS resource sets configured at the UE.

Aspect 34: The method of any of aspects 30 through 33, wherein transmitting the one or more control messages further comprises: transmitting an indication of a first maximum rank value corresponding to a quantity of layers of the first uplink shared channel message associated with a first control resource set index value, wherein the second uplink shared channel message associated with a second control resource set index value partially overlaps with the first uplink shared channel message; or transmitting the indication of the first maximum rank value corresponding to the quantity of layers of the first uplink shared channel message associated with the first control resource set index value, wherein the second uplink shared channel message associated with the second control resource set index value is absent.

Aspect 35: The method of aspect 34, further comprising: transmitting a second indication of a second maximum rank value corresponding to the quantity of layers of the second uplink shared channel message associated with the second control resource set index value.

Aspect 36: The method of aspect 35, wherein the first maximum rank value and the second maximum rank value are the same or different.

Aspect 37: The method of any of aspects 35 through 36, wherein the first maximum rank value and the second maximum rank value are configured in accordance with at least one of a control message format, a bandwidth part, a component carrier, or a combination thereof.

Aspect 38: The method of any of aspects 30 through 37, wherein receiving the at least one uplink shared channel message further comprises: receiving the at least one uplink shared channel message in accordance with one or more rules associated with a quantity of a plurality of SRS resources, wherein the one or more rules state that a first maximum quantity of SRS resources is to be indicated for the first uplink shared channel message associated with a first control resource set index value, wherein the second uplink shared channel message associated with a second control resource set index value partially overlaps with the first uplink shared channel message in a common component carrier.

Aspect 39: The method of aspect 38, wherein the one or more rules state that a second maximum quantity of the SRS resources is to be indicated for the second uplink shared channel message associated with the second control resource set index value.

Aspect 40: The method of aspect 39, further comprising: transmitting a control message indicating the first maximum quantity of the SRS resources and the second maximum quantity of the SRS resources.

Aspect 41: The method of any of aspects 39 through 40, wherein a summation of the first maximum quantity of the SRS resources and the second maximum quantity of the SRS resources is less than or equal to the at least one maximum rank value.

Aspect 42: The method of any of aspects 30 through 41, wherein transmitting the one or more control messages further comprises: transmitting an indication of a first SRS resource set of the plurality of SRS resource sets and a second SRS resource set of the plurality of SRS resource sets, wherein the first SRS resource set is associated with the first uplink shared channel message and the second SRS resource set is associated with the second uplink shared channel message.

Aspect 43: The method of aspect 42, wherein receiving the at least one uplink shared channel message further comprises: receiving the at least one uplink shared channel message in accordance with one or more rules associated with the plurality of SRS resource sets, wherein the one or more rules state that a first maximum quantity of SRS resources comprising a subset of the first SRS resource set is to be indicated for the first uplink shared channel message associated with a first control resource set index value, wherein the second uplink shared channel message associated with a second control resource set index value partially overlaps with the first uplink shared channel message in a common component carrier.

Aspect 44: The method of aspect 43, wherein the one or more rules state that a second maximum quantity of SRS resources comprising a subset of the second SRS resource set is to be indicated for the second uplink shared channel message associated with the second control resource set index value.

Aspect 45: The method of aspect 44, further comprising: transmitting a control message indicating the first maximum quantity of the SRS resources and the second maximum quantity of the SRS resources.

Aspect 46: The method of any of aspects 44 through 45, further comprising: receiving, via a capability report, information indicating the first maximum quantity of the SRS resources and the second maximum quantity of the SRS resources.

Aspect 47: The method of any of aspects 44 through 46, wherein the first maximum quantity of the SRS resources is equal to half of the first SRS resource set and the second maximum quantity of the SRS resources is equal to half of the second SRS resource set.

Aspect 48: The method of any of aspects 30 through 47, wherein transmitting the one or more control messages further comprises: transmitting an indication of a first SRS resource set of the plurality of SRS resource sets for the first uplink shared channel message associated with a first control resource set index value, wherein the second uplink shared channel message associated with a second control resource set index value is absent; or transmitting the indication of a second SRS resource set of the plurality of SRS resource sets for the second uplink shared channel message associated with the second control resource set index value, wherein the first uplink shared channel message associated with the first control resource set index value is absent; or transmitting the indication of a third SRS resource set of the plurality of SRS resource sets for the first uplink shared channel message associated with the first control resource set index value, wherein the second uplink shared channel message associated with the second control resource set index value partially overlaps with the first uplink shared channel message; or transmitting the indication of a fourth SRS resource set of the plurality of SRS resource sets for the second uplink shared channel message associated with the second control resource set index value, wherein the first uplink shared channel message associated with the first control resource set index value partially overlaps with the second uplink shared channel message.

Aspect 49: The method of aspect 48, wherein the first SRS resource set and the third SRS resource set are associated with a common channel state information resource set and a common set of power control parameters.

Aspect 50: The method of any of aspects 48 through 49, wherein the second SRS resource set and the fourth SRS resource set are associated with a common channel state information resource set and a common set of power control parameters.

Aspect 51: The method of any of aspects 48 through 50, wherein a quantity of resources in the third SRS resource set is less than a quantity of resources in the first SRS resource set.

Aspect 52: The method of any of aspects 48 through 51, wherein a quantity of resources in the fourth SRS resource set is less than a quantity of resources in the second SRS resource set.

Aspect 53: The method of any of aspects 30 through 52, wherein transmitting the one or more control messages further comprises: transmitting an indication of a first maximum rank value corresponding to the first uplink shared channel message associated with a first control resource set index value, wherein the second uplink shared channel message associated with a second control resource set index value is absent; or transmitting the indication of a second maximum rank value corresponding to the first uplink shared channel message associated with the first control resource set index value and a third maximum rank value corresponding to the second uplink shared channel message associated with the second control resource set index value, wherein the second uplink shared channel message associated with the second control resource set index value partially overlaps with the first uplink shared channel message.

Aspect 54: The method of aspect 53, wherein the second maximum rank value and the third maximum rank value are the same or different.

Aspect 55: The method of any of aspects 53 through 54, wherein the second maximum rank value and the third maximum rank value are configured in accordance with at least one of a control message format, a bandwidth part, a component carrier, or a combination thereof.

Aspect 56: The method of any of aspects 53 through 55, wherein a summation of the second maximum rank value and the third maximum rank value is less than or equal to the first maximum rank value.

Aspect 57: The method of any of aspects 53 through 56, further comprising: transmitting a control message comprising an indication of SRS resource set selection, wherein interpreting the one or more SRS resource indicator fields is based at least in part on the indication of SRS resource set selection and the first control resource set index value or the second control resource set index value.

Aspect 58: The method of any of aspects 30 through 57, wherein the one or more control messages comprise an indication of a presence of multiple uplink shared channel messages that overlap at least partially in a time domain.

Aspect 59: A UE for wireless communication, comprising one or more memories and one or more processors coupled to the one or more memories and individually or collectively configured to perform a method of any of aspects 1 through 29.

Aspect 60: A UE for wireless communication, comprising at least one means for performing a method of any of aspects 1 through 29.

Aspect 61: A non-transitory computer-readable medium storing code for wireless communication, the code comprising instructions executable by one or more processors to perform a method of any of aspects 1 through 29.

Aspect 62: A network entity for wireless communication, comprising one or more memories and one or more processors coupled to the one or more memories and individually or collectively configured to perform a method of any of aspects 30 through 58.

Aspect 63: A network entity for wireless communication, comprising at least one means for performing a method of any of aspects 30 through 58.

Aspect 64: A non-transitory computer-readable medium storing code for wireless communication, the code comprising instructions executable by one or more processors to perform a method of any of aspects 30 through 58.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled to the one or more memories and individually or collectively configured to:
receive one or more control messages that indicate:
a quantity of a plurality of sounding reference signal (SRS) resource sets, a quantity of one or more SRS resource indicator fields included in one or more control messages, and a set of parameters for multiple uplink shared channel messages, wherein the plurality of SRS resource sets are configured for non-codebook usage, and
at least one maximum rank value that be associated with uplink shared channel transmissions from the UE, the at least one maximum rank value being based at least in part on a threshold quantity of rank values supported by the UE;
receive a downlink control information message comprising downlink control information that schedules at least one uplink shared channel message, the downlink control information message including the one or more SRS resource indicator fields;
interpret the one or more SRS resource indicator fields based at least in part on a quantity of the at least one maximum rank value; and
transmit the at least one uplink shared channel message in accordance with interpreting the one or more SRS resource indicator fields.

2. The UE of claim 1, wherein the one or more processors are individually or collectively further configured to:
receive an indication of a configuration associated with the at least one maximum rank value, wherein the configuration is either a first configuration or a second configuration, wherein:
the first configuration indicates that, if the at least one uplink shared channel message is associated with a single SRS resource set, a maximum rank value associated with the at least one uplink shared channel message is equal to a larger of a first maximum rank value associated with a first SRS resource set and a second maximum rank value associated with a second SRS resource set, and
the second configuration indicates that, if the at least one uplink shared channel message is associated with the single SRS resource set, the maximum rank value associated with the at least one uplink shared channel message is equal to a summation of the first maximum rank value associated with the first SRS resource set and the second maximum rank value associated with the second SRS resource set.

3. The UE of claim 2, wherein the one or more processors are individually or collectively further configured to:
transmit, via a capability report, information associated with the maximum rank value the UE is capable of supporting when the at least one uplink shared channel message is associated with the single SRS resource set, or when the at least one uplink shared channel message is associated with multiple SRS resource sets, or both.

4. The UE of claim 1, wherein, to receive the one or more control messages, the one or more processors are individually or collectively further configured to:
receive an indication of a respective maximum rank value for each respective SRS resource set of the plurality of SRS resource sets configured at the UE.

5. The UE of claim 1, wherein, to receive the one or more control messages, the one or more processors are individually or collectively further configured to:
receive an indication of a first maximum rank value corresponding to a quantity of layers of a first uplink shared channel message associated with a first control resource set index value, wherein a second uplink shared channel message associated with a second control resource set index value partially overlaps with the first uplink shared channel message; or
receive the indication of the first maximum rank value corresponding to the quantity of layers of the first uplink shared channel message associated with the first control resource set index value, wherein the second uplink shared channel message associated with the second control resource set index value is absent.

6. The UE of claim 5, wherein the one or more processors are individually or collectively further configured to:
receive a second indication of a second maximum rank value corresponding to the quantity of layers of the second uplink shared channel message associated with the second control resource set index value.

7. The UE of claim 6, wherein the first maximum rank value and the second maximum rank value are the same or different.

8. The UE of claim 1, wherein, to transmit the at least one uplink shared channel message, the one or more processors are individually or collectively further configured to:
transmit the at least one uplink shared channel message in accordance with one or more rules associated with a quantity of a plurality of SRS resources, wherein the one or more rules state that a first maximum quantity of SRS resources is to be indicated for a first uplink shared channel message associated with a first control resource set index value, wherein a second uplink shared channel message associated with a second control resource set index value partially overlaps with the first uplink shared channel message in a common component carrier.

9. The UE of claim 8, wherein the one or more rules state that a second maximum quantity of the SRS resources is to be indicated for the second uplink shared channel message associated with the second control resource set index value.

10. The UE of claim 9, wherein the one or more processors are individually or collectively further configured to:
receive a control message indicating the first maximum quantity of the SRS resources and the second maximum quantity of the SRS resources.

11. The UE of claim 9, wherein a summation of the first maximum quantity of the SRS resources and the second maximum quantity of the SRS resources is less than or equal to the at least one maximum rank value.

12. The UE of claim 1, wherein, to receive the one or more control messages, the one or more processors are individually or collectively further configured to:
receive an indication of a first SRS resource set of the plurality of SRS resource sets and a second SRS resource set of the plurality of SRS resource sets, wherein the first SRS resource set is associated with a first uplink shared channel message and the second SRS resource set is associated with a second uplink shared channel message.

13. The UE of claim 12, wherein, to transmit the at least one uplink shared channel message, the one or more processors are individually or collectively further configured to:
transmit the at least one uplink shared channel message in accordance with one or more rules associated with the plurality of SRS resource sets, wherein the one or more rules state that a first maximum quantity of SRS resources comprising a subset of the first SRS resource set is to be indicated for the first uplink shared channel message associated with a first control resource set index value, wherein the second uplink shared channel message associated with a second control resource set index value partially overlaps with the first uplink shared channel message in a common component carrier.

14. The UE of claim 13, wherein the one or more rules state that a second maximum quantity of SRS resources comprising a subset of the second SRS resource set is to be indicated for the second uplink shared channel message associated with the second control resource set index value.

15. The UE of claim 14, wherein the one or more processors are individually or collectively further configured to:
receive a control message indicating the first maximum quantity of the SRS resources and the second maximum quantity of the SRS resources.

16. The UE of claim 14, wherein the one or more processors are individually or collectively further configured to:
transmit, via a capability report, information indicating the first maximum quantity of the SRS resources and the second maximum quantity of the SRS resources.

17. The UE of claim 14, wherein the first maximum quantity of the SRS resources is equal to half of the first SRS resource set and the second maximum quantity of the SRS resources is equal to half of the second SRS resource set.

18. The UE of claim 1, wherein the one or more control messages comprise an indication of a presence of multiple uplink shared channel messages that overlap at least partially in a time domain.

19. A network entity for wireless communication, comprising:
one or more memories; and
one or more processors coupled to the one or more memories and individually or collectively configured to:
transmit one or more control messages that indicate:
a quantity of a plurality of sounding reference signal (SRS) resource sets, a quantity of one or more SRS resource indicator fields included in one or more control messages, and a set of parameters for multiple uplink shared channel messages, wherein the plurality of SRS resource sets are configured for non-codebook usage, and
at least one maximum rank value that be associated with uplink shared channel transmissions from a user equipment (UE), the at least one maximum rank value being based at least in part on a threshold quantity of rank values supported by the UE;
transmit a downlink control information message comprising downlink control information that schedules at least one uplink shared channel message, the downlink control information message including one or more SRS resource indicator fields; and
receive the at least one uplink shared channel message in accordance with interpreting the one or more SRS resource indicator fields, wherein the one or more SRS resource indicator fields is interpreted based at least in part on a quantity of the at least one maximum rank value.

20. The network entity of claim 19, wherein, to transmit the one or more control messages, the one or more processors are individually or collectively further configured to:
transmit an indication of a configuration associated with the at least one maximum rank value, wherein the configuration is either a first configuration or a second configuration, wherein:
the first configuration indicates that, if the at least one uplink shared channel message is associated with a single SRS resource set, a maximum rank value associated with the at least one uplink shared channel message is equal to a larger of a first maximum rank value associated with a first SRS resource set and a second maximum rank value associated with a second SRS resource set, and
the second configuration indicates that, if the at least one uplink shared channel message is associated with the single SRS resource set, the maximum rank value associated with the at least one uplink shared channel message is equal to a summation of the first maximum rank value associated with the first SRS resource set and the second maximum rank value associated with the second SRS resource set.

21. The network entity of claim 20, wherein the one or more processors are individually or collectively further configured to:
receive, via a capability report, information associated with the maximum rank value the UE is capable of supporting when the at least one uplink shared channel message is associated with the single SRS resource set, or when the at least one uplink shared channel message is associated with multiple SRS resource sets, or both.

22. The network entity of claim 19, wherein, to transmit the one or more control messages, the one or more processors are individually or collectively further configured to:
transmit an indication of a respective maximum rank value for each respective SRS resource set of the plurality of SRS resource sets configured at the UE.

23. The network entity of claim 19, wherein, to transmit the one or more control messages, the one or more processors are individually or collectively further configured to:
transmit an indication of a first maximum rank value corresponding to a quantity of layers of a first uplink shared channel message associated with a first control resource set index value, wherein a second uplink shared channel message associated with a second control resource set index value partially overlaps with the first uplink shared channel message; or
transmit the indication of the first maximum rank value corresponding to the quantity of layers of the first uplink shared channel message associated with the first control resource set index value, wherein the second uplink shared channel message associated with the second control resource set index value is absent.

24. The network entity of claim 23, wherein the one or more processors are individually or collectively further configured to:
transmit a second indication of a second maximum rank value corresponding to the quantity of layers of the second uplink shared channel message associated with the second control resource set index value.

25. The network entity of claim 24, wherein the first maximum rank value and the second maximum rank value are the same or different.

26. The network entity of claim 19, wherein, to receive the at least one uplink shared channel message, the one or more processors are individually or collectively further configured to:
receive the at least one uplink shared channel message in accordance with one or more rules associated with a quantity of a plurality of SRS resources, wherein the one or more rules state that a first maximum quantity of SRS resources is to be indicated for a first uplink shared channel message associated with a first control resource set index value, wherein a second uplink shared channel message associated with a second control resource set index value partially overlaps with the first uplink shared channel message in a common component carrier.

27. The network entity of claim 26, wherein the one or more rules state that a second maximum quantity of the SRS resources is to be indicated for the second uplink shared channel message associated with the second control resource set index value.

28. The network entity of claim 27, wherein the one or more processors are individually or collectively further configured to:
transmit a control message indicating the first maximum quantity of the SRS resources and the second maximum quantity of the SRS resources.

29. A method for wireless communication by a user equipment (UE), comprising:
receiving one or more control messages that indicate:
a quantity of a plurality of sounding reference signal (SRS) resource sets, a quantity of one or more SRS resource indicator fields included in one or more control messages, and a set of parameters for multiple uplink shared channel messages, wherein the plurality of SRS resource sets are configured for non-codebook usage, and
at least one maximum rank value that is associated with uplink shared channel transmissions from the UE, the at least one maximum rank value being based at least in part on a threshold quantity of rank values supported by the UE;
receiving a downlink control information message comprising downlink control information that schedules at least one uplink shared channel message, the downlink control information message including the one or more SRS resource indicator fields;
interpreting the one or more SRS resource indicator fields based at least in part on a quantity of the at least one maximum rank value; and
transmitting the at least one uplink shared channel message in accordance with interpreting the one or more SRS resource indicator fields.

30. A method for wireless communication by a network entity, comprising:
transmitting one or more control messages that indicate:
a quantity of a plurality of sounding reference signal (SRS) resource sets, a quantity of one or more SRS resource indicator fields included in one or more control messages, and a set of parameters for multiple uplink shared channel messages, wherein the plurality of SRS resource sets are configured for non-codebook usage, and
at least one maximum rank value that is associated with uplink shared channel transmissions from a user equipment (UE), the at least one maximum rank value being based at least in part on a threshold quantity of rank values supported by the UE;
transmitting a downlink control information message comprising downlink control information that schedules at least one uplink shared channel message, the downlink control information message including one or more SRS resource indicator fields; and
receiving the at least one uplink shared channel message in accordance with interpreting the one or more SRS resource indicator fields, wherein the one or more SRS resource indicator fields is interpreted based at least in part on a quantity of the at least one maximum rank value.
